(19) United States
(12) Patent Application Publication
(10) Pub. No.: US 2008/0052378 A1
(43) Pub. Date: Feb. 28, 2008

(54) NETWORK ANALYSIS ASSISTING APPARATUS AND METHOD, PROGRAM AND RECORDING MEDIUM

(76) Inventors: Shinako Matsuyama, Tokyo (JP); Yu Hamada, Tokyo (JP); Tetsuya Shiraishi, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/842,627

(22) Filed: Aug. 21, 2007

(30) Foreign Application Priority Data
Aug. 24, 2006 (JP) 2006-227866

(51) Int. Cl. G06F 15/16

(52) U.S. Cl. 709/218

(57) ABSTRACT

A network analysis assisting apparatus for assisting analysis of a network formed from a plurality of nodes and edges indicating interconnection between the nodes includes an edge attribute setting unit that sets an edge attribute indicating a meaning of the interconnection, to each of the edges.

### BACKGROUND OF THE INVENTION

1. Field of the Invention

The present invention relates to a network analysis assisting apparatus and method, a program and a recording medium, and more particularly to a network analysis assisting apparatus and method allowing a user to analyze a network easily, and a program and a recording medium.

2. Description of Related Art

There is a related art approach to analyzing the tendencies and features of a set of elements by analyzing the set as a network using each element as a node and edges interconnecting related elements. In order to assist this analysis, there has also been an approach to visualize (graph representation) a target network for analysis.

For example, in genome researches or the like, the relevancy, particularly commonness, of particular genes among a number of target data items has been paid attention, and a method has been proposed by which first and second networks are displayed in order for an analyzer to intuitively grasp the features of the particular genes, in the first network, two element nodes having a common attribute being connected by an edge, and in the second network, an element node and an attribute node having an attribute possessed by the element node being connected by an edge (e.g., refer to Japanese Patent Application Publication No. 2004-265179).

Further, for example, there is another method of creating a relevancy graph by representing a relevancy in graph format among objects in accordance with an attribute of each object and two objects having an edge intensity not smaller than a predetermined amount are coupled by an edge, in order to visually and easily confirm the relevancy among arbitrary objects (e.g., refer to Japanese Patent Application Publication No. 2006-39990).

### SUMMARY OF THE INVENTION

More complicated networks are analyzed in recent years, and a variety of analyzing methods are required for this purpose. However, related art methods are unable, for example, to define an attribute of an edge representative of the meaning of interconnection between nodes and to conduct a variety of filtering and calculation processes and the like for nodes and edges. There is therefore a fear that a network cannot be analyzed easily in accordance with the qualities of nodes and edges.

For example, according to the method described in Japanese Patent Application Publication No. 2004-265179, an edge indicates only the attribute shared between nodes, and a variety of relations among nodes cannot be indicated. It is therefore unable to define an attribute of an edge representative of the meaning of interconnection between nodes. A variety of analyzing processes such as filtering processes can neither be executed. According to the method described in Japanese Patent Application Publication No. 2006-39990, although an edge intensity representative of a frequency is defined, it is unable to define an attribute of an edge representative of the meaning of interconnection between nodes. A variety of analyzing processes can neither be executed.

Accordingly, it is desirable that attributes of not only a node but also an edge can be defined, whereby a user can analyze a network easily and a variety of analyzing processes can be executed by using attributes. The present invention is made in view of the above-described circumstance.

According to one embodiment of the present invention, there is provided a network analysis assisting apparatus for assisting analysis of a network formed from a plurality of nodes and edges indicating interconnection between the nodes. The apparatus includes edge attribute setting means for setting an edge attribute indicating a meaning of the interconnection, to each of the edges.

The network analysis assisting apparatus may further include display control means for visualizing the network as a graph and displaying the graph on a monitor. The display control means displays the graph so as to indicate the edge attributes by visual features.

The network analysis assisting apparatus may further include edge attribute selecting means for receiving a designation of the edge attribute, and selecting and extracting edges having the designated edge attribute and nodes connected to the edges, from the network. The display control means display only the edges and the nodes selected by the edge attribute selecting means.

The network analysis assisting apparatus may further include edge designation analyzing means for receiving a designation of the edge attribute, and extracting a node group interconnected by edges having the designated edge attribute, from the network.

The network analysis assisting apparatus may further include score calculating means for calculating a node score representative of a weight of each of the nodes.

Based on an edge score representative of a weight of an edge connected to a target node for process, the score calculating means may calculate the node score of the target node for process.

Based on a node score of another node connected via the edge to a target node for process, the node score of the target node for process may be calculated.

According to another embodiment of the present invention, there is provided a network analysis assisting method, a program for execute the method or a recording medium recording the program, for assisting analysis of a network formed from a plurality of nodes and edges indicating interconnection between the nodes.

The method includes an edge attribute setting step of setting an edge attribute indicating a meaning of the interconnection, to each of the edges.

According to the embodiments of the present invention, the edge attribute indicating a meaning of the interconnection between nodes can be set to each edge.

According to the embodiments of the present invention, a network can be analyzed. The attribute of not only the node but also the edge can be defined and various analyses are possible by using the attributes, in order particularly for a user to facilitate an analysis of a network.

### BRIEF DESCRIPTION OF THE DRAWINGS

FIG. 1 is a block diagram showing an example of the structure of a network analysis assisting apparatus adopting the present invention;

FIG. 2 is a diagram showing an example of graph display;

FIG. 3 is a diagram showing an example of the structure of graph data;

FIG. 4 is a diagram showing an example of the structure of functional blocks;

FIG. 5 is a flow chart illustrating an example of the sequence of a main menu process;

FIG. 6 is a flow chart illustrating an example of the sequence of a graph creating process;

FIG. 7 is a flow chart illustrating an example of the sequence of a graph routine updating process;

FIG. 8 is a flow chart illustrating an example of the sequence of an attribute setting process;

FIG. 9 is a flow chart illustrating an example of the sequence of the attribute setting process following the flow chart of FIG. 8;

FIG. 10 is a diagram showing another example of graph display;

FIG. 11 is a flow chart illustrating an example of the sequence of a display control process;

FIG. 12 is a flow chart illustrating another example of the sequence of the display control process;

FIG. 13 is a flow chart illustrating an example of the sequence of an analyzing process;

FIG. 14 is a flow chart illustrating an example of the sequence of the analyzing process following the flow chart of FIG. 13;

FIG. 15 is a diagram showing an example of analyzed results;

FIG. 16 is a flow chart illustrating another example of the sequence of the analyzing process;

FIGS. 17(A) to 17(C) are diagrams illustrating specific examples of node score calculation;

FIG. 18 is a diagram showing still another example of graph display;

FIG. 19 is a flow chart illustrating still another example of the sequence of the analyzing process;

FIG. 20 is a flow chart illustrating an example of the sequence of a holding process;

FIG. 21 is a flow chart illustrating an example of the sequence of a terminating process;

FIG. 22 is a block diagram showing an example of a configuration of a network analysis assisting system adopting the present invention; and

FIG. 23 is a block diagram showing an example of the structure of a personal computer adopting the present invention.

### DETAILED DESCRIPTION OF EMBODIMENT

In the following description of the embodiments of the present invention, the correspondence between the disclosed inventions and the embodiments is as follows. The description is used for confirming that the embodiments supporting the inventions described in this specification are described in the specification. Therefore, the embodiment described in this specification as not corresponding to some invention is not intended to mean that the embodiment does not correspond to the invention. Conversely, the embodiment described in this specification as corresponding to some invention is not intended to mean that the embodiment does not correspond to the invention other than some invention.

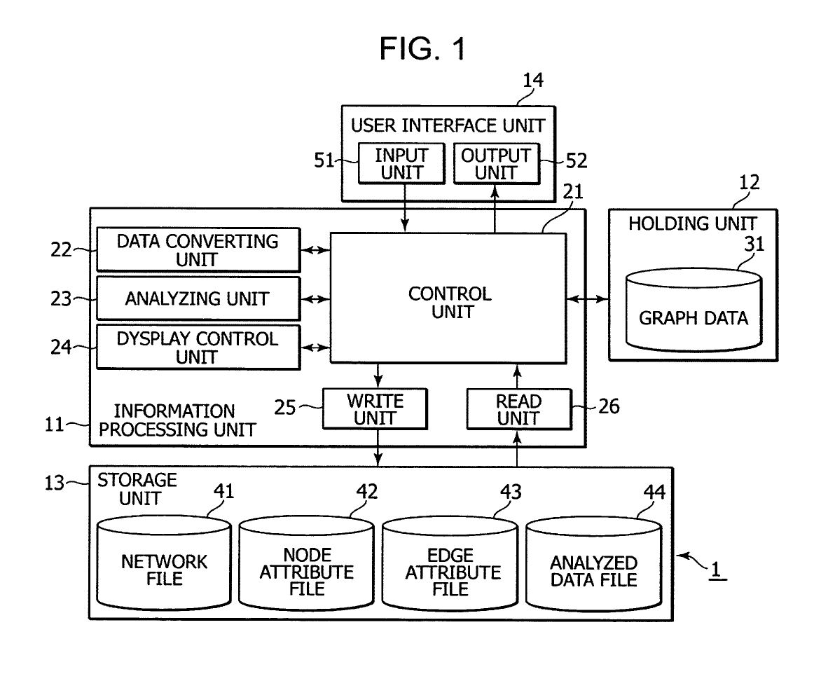

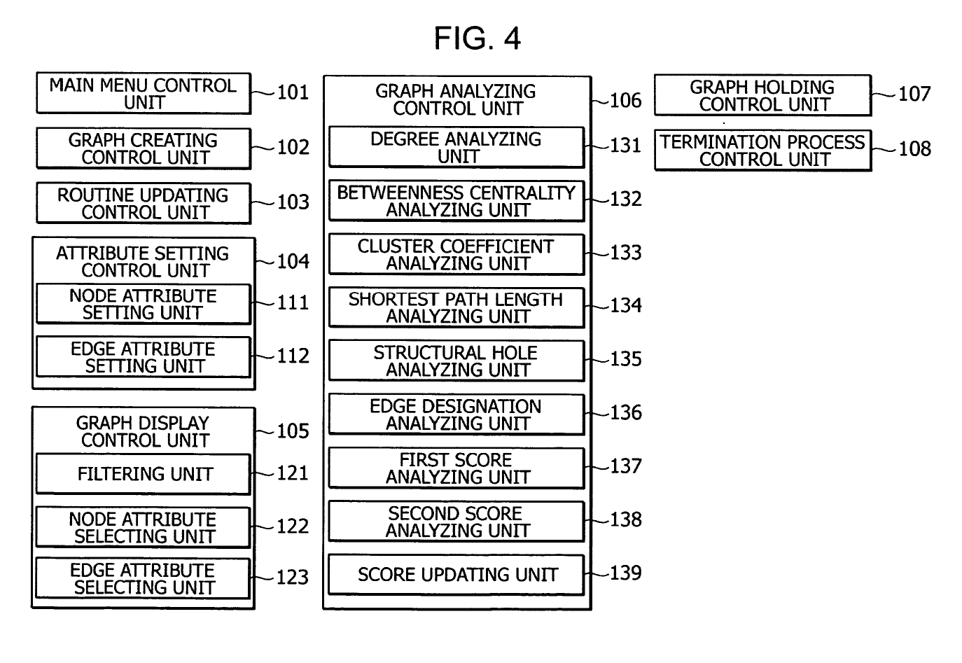

According to one embodiment of the present invention, a network analysis assisting apparatus (e.g., a network analysis assisting apparatus 1 shown in FIG. 1) for assisting analysis of a network formed from a plurality of nodes and edges indicating interconnection between the nodes, includes: edge attribute setting means (e.g., an edge attribute setting unit 112 shown in FIG. 4) for setting an edge attribute indicating a meaning of the interconnection, to each of the edges.

The network analysis assisting apparatus may further include display control means (e.g., a display control unit 24 shown in FIG. 1) for visualizing the network as a graph and displaying the graph on a monitor, wherein the display control means displays the graph so as to indicate the edge attribute by visual features.

The network analysis assisting apparatus may further include edge attribute selecting means (e.g., an edge attribute setting unit 123 shown in FIG. 4) for receiving a designation of the edge attribute, and selecting and extracting edges having the designated edge attribute and nodes connected to the edges, from the network, wherein the display control means display only the edges and the nodes selected by the edge attribute selecting means.

The network analysis assisting apparatus may further include edge designation analyzing means (e.g., an edge designation analyzing unit 136 shown in FIG. 4) for receiving a designation of the edge attribute, and extracting a node group interconnected by edges having the designated edge attribute, from the network.

The network analysis assisting apparatus may further include score calculating means (e.g., a first score analyzing unit 137 or a second score analyzing unit 138 shown in FIG. 4) for calculating a node score representative of a weight of each of the nodes.

According to another embodiment of the present invention, a network analysis assisting method, a program or a recording medium recording the program, for assisting analysis of a network formed from a plurality of nodes and edges indicating interconnection between the nodes, includes: an edge attribute setting step of setting an edge attribute indicating a meaning of the interconnection, to each of the edges.

Embodiments of the present invention will now be described.

FIG. 1 is a block diagram showing an example of the structure of a network analysis assisting system adopting the present invention.

Referring to FIG. 1, the network analysis assisting apparatus 1 is an information processing apparatus for assisting a network analysis work by visualizing (graph representation) a set of elements as a network using each element as a node and edges representative of the relation (interconnection) among elements, thereby allowing a user performing analysis to intuitively (visually) grasp the features and tendencies of the set.

As shown in FIG. 1, the network analysis assisting apparatus 1 has: as its major constituents, an information processing unit 11 which is a processing unit for executing various processes such as a data converting process, an analyzing process and a display control process; a holding unit 12 for holding generated graph data 31; a storage unit 13 for storing information on nodes and edges as files; and a user interface unit 14 including input-output devices for users and the like such as a monitor and a keyboard.

The information processing unit 11 includes: a control unit 21; a data converting unit 22, an analyzing unit 23, a display control unit 24, a write unit 25 and a read unit 26. The control unit 21 controls each constituent and executes a network analysis assisting process, as will be later described. Functional blocks in the control unit 21 will be later described.

The data converting unit 22 is a unit for executing a data conversion related process under control of the control unit 21, and generates graph data 31, for example, by representing nodes and edges described in record data (file) in graph format and defining the attributes of nodes and edges in a graph. Conversely, the data converting unit 22 converts (files) a graphed network into record data under control of the control unit 21.

The analyzing unit 23 analyzes a network graphed by the graph data 31 by an analyzing method designated by the control unit 21, and returns the analyzed results to the control unit 21. The display control unit 24 executes a display process for a graphed network and the like. The write unit 25 writes data (file) into the storage unit 13, and the read unit 26 reads data (file) stored in the storage unit 13.

The holding unit 12 includes a volatile memory such as a random access memory (RAM), and temporarily holds results and intermediate progresses by the control unit 21. For example, as shown in FIG. 1, the holding unit 12 holds the graph data 31 generated by representing a network in graph format under control of the control unit 21.

The storage unit 13 includes a large capacity nonvolatile storage medium such as a hard disk and a flash memory, and stores various data filed for storage. For example, as shown in FIG. 1, the storage unit 13 holds: a network file 41 including information on nodes, edges and relations thereof, a node attribute file 42 including information on node attributes representative of features of each node; an edge attribute file 43 including information on edge attributes representative of features of each edge; an analyzed data file 44 including analyzed data of a network; and the like.

The network file 41 stores text data describing a list of nodes and edges of a network. For example, if a node is a user, names such as user 1, user 2, user 3, . . . are assigned to nodes as node names, and the network file 41 includes a list of such node names. The network file 41 further includes a list of information on edges indicating which node is coupled to which node by an edge.

The node attribute file 42 stores text data describing a list of node attributes of nodes in a network. A node attribute is information on the features and the like of each node. For example, if a node is a user, the node attribute may be gender, age, occupation, address, hobby and the like of the user. Namely, the node attribute is information on the meaning of one element in a network.

The edge attribute file 43 stores text data describing a list of edge attributes of edges in a network. An edge attribute is information on the features and the like of each edge. For example, if a node is a user and an edge is a human relation, the edge attribute may be items indicating the features of human relation such as same hobby, class mate, gender, and speech. Namely, the edge attribute is information on the meaning of interconnection between elements in a network.

The analyzed data file 44 stores text data of analyzed results of a network by the analyzing unit 23.

These files include, for example, text files or comma separated values (CSV) files. Data other than text data may obviously be stored.

The user interface unit 14 has an input unit 51 such as a keyboard and a mouse and an output unit 52 such as a monitor and a speaker, and executes a process for an user interface by executing a process for image display and user designation input reception under control of the control unit 21.

Under control of the control unit 21, the network analysis assisting apparatus 1 makes the input unit 51 receive a user designation, makes the read unit 26 read the network file 41 stored in the storage unit 13, makes the data converting unit 22 perform the graph representation of a list of nodes and edges stored in the network file 41, makes the holding unit 12 hold generated graph data 31, and makes the display control unit 24 display graph images on a monitor of the output unit 52. If there exist the node attribute file 42, edge attribute file 43, analyzed data file 44 and the like, the data converting unit 22 reflects various data stored in these files upon the graphed network.

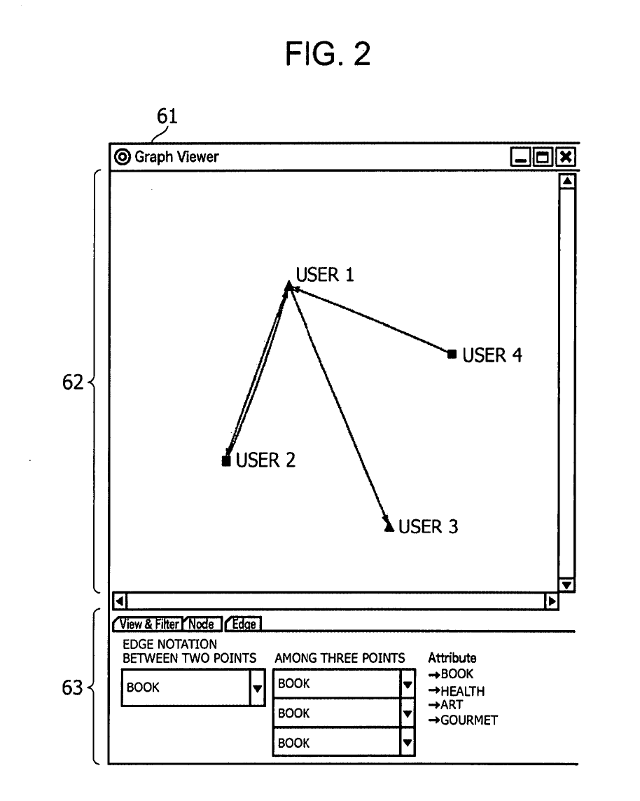

In this manner, the network analysis assisting apparatus 1 images a network described in the network file 41 and the like as a graph and displays the graph on the monitor. FIG. 2 shows an example of graph display on the monitor of the output unit. As shown in FIG. 2, when a graph is displayed, a graph viewer 61 as a graphical user interface (GUI) is displayed on the monitor screen as a window. The graph viewer 61 includes a display area 62 and an operation area 63, and a graph is displayed in the display area 62. A user operates a GUI button or the like disposed in the operation area 63 so that the graph displayed in the display area 62 can be analyzed and edited.

Next, a graph displayed in the display area 62 in FIG. 2 will be described. In FIG. 2, points (triangles and squares) drawn as user 1 to user 4 represent nodes, and arrow symbols interconnecting nodes represent edge. The network is formed from nodes representative of elements, and edges representative of the relations among the nodes. Graph representation is performed in such a manner that the node attribute is represented by visual features such as shape, color, pattern, density and size of the point representative of the node, and that the edge attribute is represented by visual features such as color, pattern, solid line, dotted line, chain line, density and size of the arrow symbol representative of the edge. A direction of an arrow symbol indicates a direction of the relation between nodes at opposite ends of an edge (e.g., a direction of reference relation and a direction of dependency relation).

For example, the network shown in FIG. 2 indicates a usage state of speech services such as telephone, and the network is graphed in such a manner that the node indicates a member (user) of the speech services, the edge indicates usage of the speech services between users, the shape of the node indicates gender of the user, a direction of the arrow symbol of the edges indicates a teller and a receiver, and a visual difference of the arrow symbol indicates a speech frequency and main speech contents (e.g., statistical information acquired by questionnaire results).

Graph representation (visualization) of a network in this manner allows an analyzer to visually grasp the features and tendencies of the network, such as “user 1 not only has the highest service usage frequency but also is the common speech partner of user 2 to user 4, and serves as a large factor of making user 2 to user 4 use services”, and provides easy analysis. The network analysis assisting apparatus 1 not only simply visualizes the network but also has various analyzing functions and the like to be later described. Therefore, the analyzer can further deepen the analysis and perform sophisticated analyses such as which user influences greatly the whole services, how services are used between users having what relation, and which services are accepted most. Namely, the network analysis assisting apparatus 1 can assist such sophisticated analyses.

A graphed network may display any type of data so long as the network is formed from nodes representative of elements and edges representative of the relation among nodes. For example, the network may display not only the usage state of various services but also protein structures, statistical information, network of electronic apparatus such as LAN, and the like. Namely, nodes and edges may represent any items. Further, arbitrary items may be assigned to the attributes of nodes and edges.

In FIG. 2, the network is graphed to a directed graph using an arrow symbol as the edge, i.e., the graph indicating also a direction of the relation between nodes. The network may be graphed to a non-directed graph using a line segment as the edge, i.e., the graph not considering the direction of the relation between nodes.

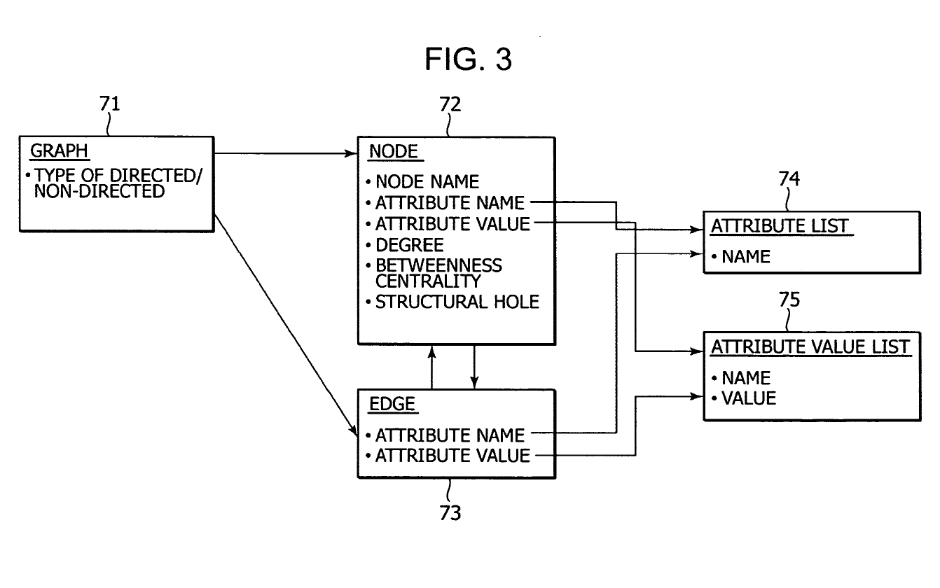

The graph data 31 (FIG. 1) representing a network as a graph in this manner has a structure such as shown in FIG. 3. In the example shown in FIG. 3, the graph data 31 has a graph 71 including information on the whole graph, a node 72 including information on each node, an edge 73 including information on each edge, an attribute list 74 including information on node and edge attributes, and an attribute value list 75.

The graph 71 includes a directed type or a non-directed type which is information on whether a network is displayed by a directed graph or a non-directed graph. The node 72 includes information on each node in a graph indicated by the graph 71, the node information including: a node name representative of the name of the node; an attribute name representative of the name of a node attribute; an attribute value representative of a value of a node attribute; a degree representative of the number of connected edges; a betweenness centrality representative of an influence degree upon another node; a structural hole representative of relation disconnection (a duplication degree of the relation between nodes indicated by an edge and the relation between nodes indicated by another edge); and the like. The edge 73 includes information on each edge in a graph represented by the graph 71, the information including: an attribute name representative of the name of an edge attribute; an attribute value representative of the value of an edge attribute; and the like. The attribute list 74 is a list of the name of the node attribute of each node indicated in the node 72 and the name of the edge attribute of each edge indicated in the edge 73. The attribute value list 75 is a list of the name and attribute value of each node attribute indicated in the node 72 and the name and attribute value of each edge attribute indicated in the edge 73.

Based on the network file 41 and the like stored in the storage unit 13, the network analysis assisting apparatus 1 generates the graph data 31 including the various data described above, and displays the network as a graph on the monitor.

Next, description will be made on a specific process to be executed by the network analysis assisting apparatus 1. FIG. 4 is a diagram showing an example of the structure of functional blocks in the control unit 1 shown in FIG. 1.

As shown in FIG. 4, the control unit 21 includes: a main menu control unit 101 for executing a process regarding a main menu screen for receiving a selection designation of an execution process by a user; a graph creating control unit 102 for executing a process of representing a network in graph format; a routine updating control unit 103 for routinely updating a graph; an attribute setting control unit 104 for executing a process regarding settings of nodes and edges; a graph display control unit 105 for executing a process regarding graph display; a graph analyzing control unit 106 for executing a process regarding graph analysis; a graph holding control unit 107 for executing a process regarding graph holding; and a termination processing control unit 108 for controlling a termination process.

The attribute setting control unit 104 has a node attribute setting unit 111 for executing a process regarding settings of node attributes, and an edge attribute setting unit 112 for executing a process regarding settings of edge attributes. The graph display control unit 105 has a filtering unit 121 for executing a filtering process using various conditions to limit nodes and edges to be displayed, a node attribute selecting unit 122 for selecting nodes and edges by using node attributes, and an edge attribute selecting unit 123 for selecting nodes and edges by using edge attributes.

The graph analyzing control unit 106 includes: a degree analyzing unit 131 for analyses using the degree of each node; a betweenness centrality analyzing unit 132 for analyses using betweenness centrality of each node; a cluster coefficient analyzing unit 133 for analyses using a clustering coefficient indicating how densely the nodes are coupled; a shortest path length analyzing unit 134 for analyses using the shortest path length representative of a distance between nodes on an edge route (path); a structural hole analyzing unit 135 for analyses using a structural hole of a network; an edge designation analyzing unit 136 for analyses using a pattern of edge attributes of edges connected to each node; a first score analyzing unit 137 for calculating a node score indicating a node value based on connected edges; a second store analyzing unit 138 for calculating a node score based on a node score of other nodes; and a score updating unit 139 for calculating again the node score of its own node in response to updating the node score of another node.

In the following, description will be made specifically on each process by referring to flow charts.

First, a main menu process will be described. For example, when a power source of the network analysis assisting apparatus 1 is turned on or when a user designation for starting up the main menu is received, the main menu control unit 101 controls the output unit 52 to display a main menu of the monitor to receive a selection designation from a user. The main menu is a GUI for making a user perform a main selection of a process to be executed by the network analysis assisting apparatus 1.

For example, the main menu is constructed in such a manner that a user can select any one of a process of creating a graph from a network and displaying the graph, a process of routinely updating the displayed graph, a process of setting attributes, a process regarding graph display, a process regarding graph storing and a terminating process. Namely, rough selection and important process selection are performed in the main menu. If a finer selection from selected processes is required, another menu is used.

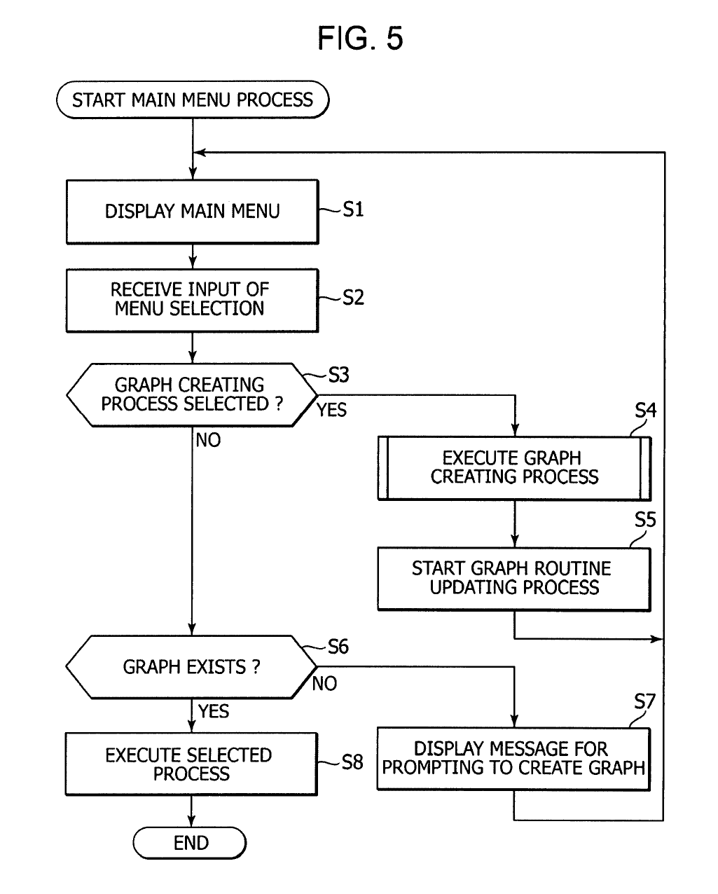

With reference to the flow chart of FIG. 5, description will be made on the main menu process to be executed by the main menu control unit 101 to execute a process regarding the main menu.

At Step S1 the main menu control unit 101 started the main menu process makes the output unit 52 display the main menu on the monitor. At Step S2 the input unit 51 is controlled to receive a main menu selection input. The main menu displays, for example, the list of process names of processes such as described previously, and a user operates the input unit 51 to move a cursor or the like and select one of the process names. With this operation, a main menu selection is input.

Upon reception of the menu selection input selecting one of the process names from the main menu, first at Step S3 the main menu control unit 101 judges whether the main menu selection input indicates a selection of a graph creating process. The graph creating process is a process of reading the network file 41 and the like from the storage unit 13 and representing the network in graph format and displaying the graph. In the initial state (e.g. turn-on of the power source) when the main menu is activated, the network file 41 and the like are still not read, and a graph is not still displayed on the monitor (because the graph data 31 is not generated). Therefore, if another process (e.g., an analyzing process and a display control process) is to be executed, the graph creating process is required to be executed at least once.

If it is judged that the graph creating process is selected, the main menu control unit 101 advances the process to Step S4. At Step S4 the graph creating control unit 102 executes the graph creating process to represent the network in graph format and display the graph on the monitor of the output unit 52, as shown in FIG. 2. After completion of the process at Step S4, at Step S5 the routine updating control unit 103 starts a graph routine updating process to routinely update the graph displayed on the monitor. As the routine updating control unit 103 starts the graph routine updating process, the main menu control unit 101 returns the process to Step S1 to repeat the succeeding processes.

If it is judged at Step S3 that the menu selection input indicates no selection of the graph creating process, the main menu control unit 101 advances the process to Step S6 whereat it is judged whether the created graph exists (whether the graph data 31 exists). As described above, if the graph data 31 does not exist, the process such as the analyzing process and display control process cannot be executed. Therefore, if it is judged that the created graph does not exist, the main menu control unit 101 advances the process to Step S7 whereat a message prompting graph creation is displayed on the monitor to thereafter return the process to Step S1 and repeat the succeeding processes.

If it is judged at Step S6 that the graph exists, the main menu control unit 101 advances the process to Step S8 to execute a process selected from processes prepared beforehand, such as attribute setting, graph display control, graph analyzing, graph holding control, and termination processes. After completion of the process at Step S8, the main menu control unit 101 terminates the main menu process.

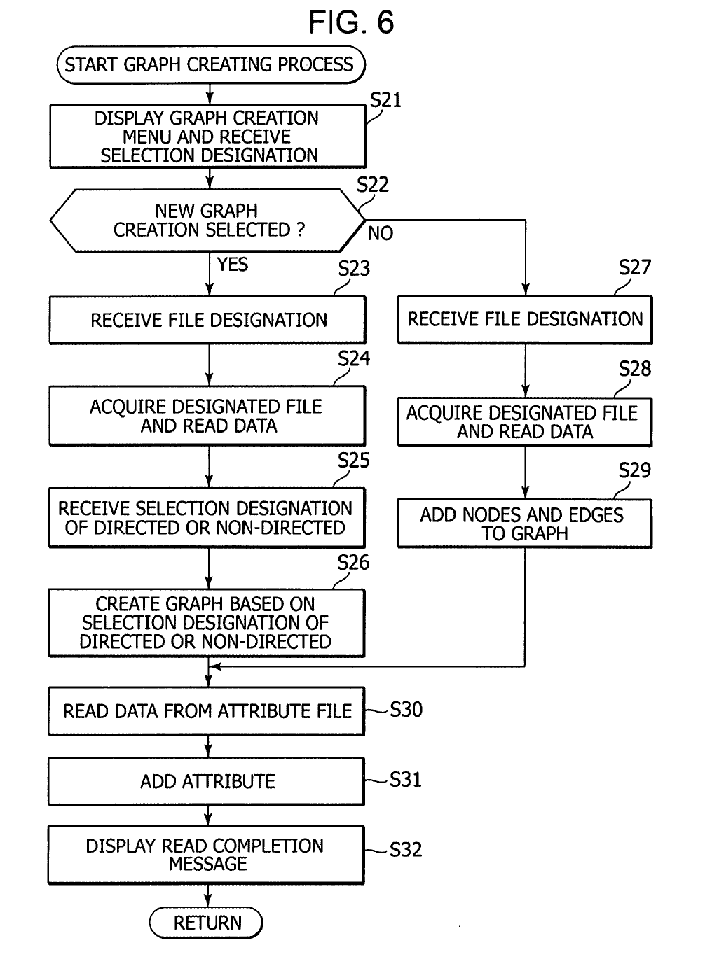

Next, with reference to the flow chart of FIG. 6, description will be made on an example of the sequence of the graph creating process to be executed at Step S4 of FIG. 5.

As the graph creating process starts, at Step S21 the graph creating control process 102 controls the output unit 52 to display a graph creating menu on the monitor, and controls the input unit 51 to receive a menu selection designation in the graph creating menu.

As described earlier, the graph creating process is a process of representing a network in graph format. In this case, a network may be graphed as a new graph, or a created graph may be added to an already existing graph to form one graph. The graph creating menu is a GUI for making a user select one of these two processes. For example, the graph creasing menu has a GUI button (or link, tab or the like) having a legend “create new graph” and a GUI button having a legend “add to already existing graph”. A user operates the input unit 51 to move a cursor and select the process by selecting one of the GUI buttons.

Upon reception of a selection designation of whether a new graph is created and displayed or whether a graph (additional graph) to be added to an already created graph (existing graph) is created to additionally display the graph, the graph creating control unit 102 advances the process to Step S22 whereat it is judged whether the selection designation indicates a selection of creating a new graph.

If it is judged that the new graph creation is selected, the graph creating control unit 102 advances the process to Step S23 to control the input unit 51 and output unit 52 to receive designation of a file name of the network file 41 to be used for graph creation, by displaying a GUI or the like. As the file name is designated, at Step S24 the graph creating control unit 102 controls the read unit 26 to read and acquire the network file 41 designated by the user from the storage unit 13 and read the data.

At Step S25 the graph creating control unit 102 controls the input unit 51 and output unit 52 to receive a directed/non-directed selection designation which is a selection designation of whether a directed graph or a non-directed graph is created, by displaying a GUI or the like. As this preparation is effected, at Step S26 the graph creating control unit 102 controls the data converting unit 22 to generate the graph data 31. As the data converting unit 22 generates the graph data 31, the graph creating control unit 102 makes the holding unit 12 hold the graph data 31, and advances the process to Step S30.

If it is judged at Step S22 that the selection designation indicates that an additional graph to be added to the existing graph is created and the existing graph added with the additional graph is displayed, then the graph creating control unit 102 advances the process to Step S27, controls the input unit 51 and output unit 52, and receives a designation of a file name of the network file 41 to be used for graph creation, by displaying a GUI or the like. As the file name is designated, at Step S28 the graph creating control unit 102 controls the read unit 26 to read and acquire the files (network file 41 and the like) designated by the user from the storage unit 13 and read the data. At Step S29 the graph creating control unit 102 controls the data converting unit 22 to make the data converting unit create the additional graph from the read data and add nodes and edges of the additional graph to the existing graph. As the data converting unit 22 adds the additional graph and updates the graph data 31, the graph creating control unit 102 makes the holding unit 12 hold the graph data 31, to thereafter advance the process to Step S30.

At Step S30 the graph creating control unit 102 reads data from the node attribute file 42 and edge attribute file 43 if these files exist, and adds at Step S31 the read attributes to the network of the graph data 31. If these attribute files do not exist, the graph creating control unit 102 omits these processes and advances the process to Step S32. After completion of adding the attributes, at Step S32 the graph creating control unit 102 controls the output unit 52 to display on the monitor a read completion message notifying a read completion to the user, and to terminate the graph creating process and return the process to Step S4 of FIG. 5 to execute the processes at Step S5 and succeeding Steps.

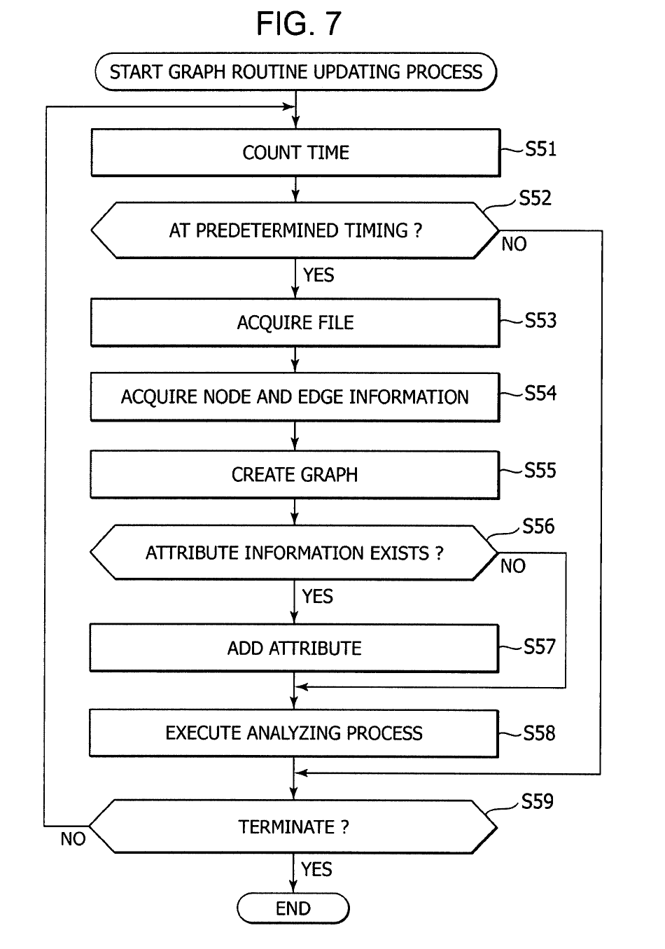

Next, with reference to the flow chart of FIG. 7, description will be made on the sequence of the graph routine updating process to be started at Step S5 of FIG. 5. The graph routine updating process is a process of routinely reflecting the update of the network file 41 upon the graph, without any designation by the user. This process is executed always in the state that there exists at least one graphed network, i.e., while the graph data 31 exists in the holding unit 12.

As the graph routine updating process starts, at Step S51 the routine updating control unit 103 counts time, and judges at Step S52 whether the present time is a predetermined fixed timing. If it is judged that the present time is the fixed timing, the process is advanced to Step S53.

At Step S53 the routine updating control unit 103 acquires the network file 41 corresponding to the graph data 31 from the storage unit 13, and reads at Step S54 the node attribute file 42 and edge attribute file 43 from the storage unit 13 to acquire the node information and edge information. At Step S55 the routine updating control unit 103 controls the data converting unit 22 to create a graph based on the acquired information. At Step S56 the routine updating control unit 103 judges whether attribute information such as node attributes and edge attribute exists. If it is judged the attribute information exists, the process is advanced to Step S57 whereat the routine updating control unit controls the data converting unit 22 to add the attributes to nodes and edges of the graph to thereafter advance the process to Step S58. If it is judged at Step S56 that the attribute information does not exist, the routine updating control unit 103 omits the process at Step S57 and advances the process to Step S58.

At Step S58 the routine updating control unit 103 controls the analyzing unit 23 to make the analyzing unit execute an analyzing process for the created (updated) graph based on predetermined fixed settings. The details of the analyzing process will be later described. After completion of the analyzing process, the routine updating control unit 103 makes the holding unit 12 hold the graph data, and controls the output unit 52 to display the graph (analyzed results) on the monitor, to thereafter advance the process to Step S59. If it is judged at Step S52 that the present time is not the fixed timing, the routine updating control unit 103 advances the process to Step S59.

At Step S59 the routine updating control unit 103 judges whether the graph routine updating process is to be terminated. For example, if it is judged that the graphed network (i.e., graph data 31) exists and the graph routine updating process is not to be terminated, the routine updating control unit 103 returns the process to Step S51 to repeat the succeeding processes. If it is judged at Step S59 that the graph routine updating process is to be terminated because the power source is to be turned on or the graph (i.e., graph data 31) to be routinely updated does not exist, the routine updating control unit 103 terminates the graph routine updating process.

In the above description, although the graph is routinely updated, this updating process may not be routinely updated, but this process may be executed, for example, when a fixed event occurs.

Next, description will be made on various processes to be executed at Step S8 of FIG. 5.

When a process other than graph creation is selected in the main menu in the state that the graph data 31 exists, the selected process is executed. The process of this type is, for example, a process that a user sets (also adds) attributes to nodes and edges of a graph displayed on the monitor. When a user selects this attribute setting process in the main menu, the attribute setting control unit 104 (FIG. 4) executes the attribute setting process.

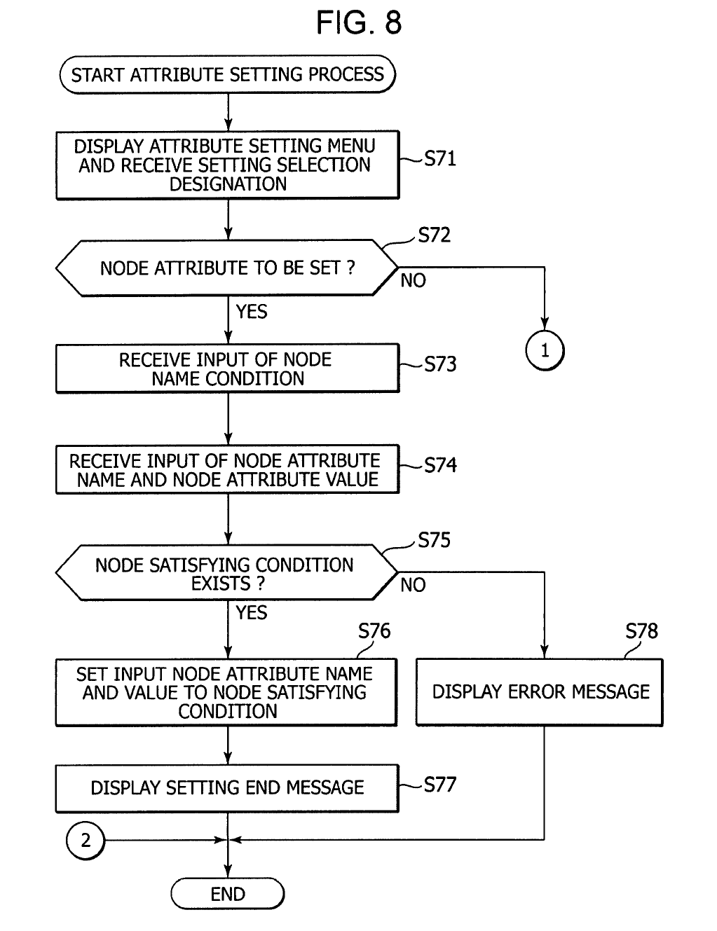

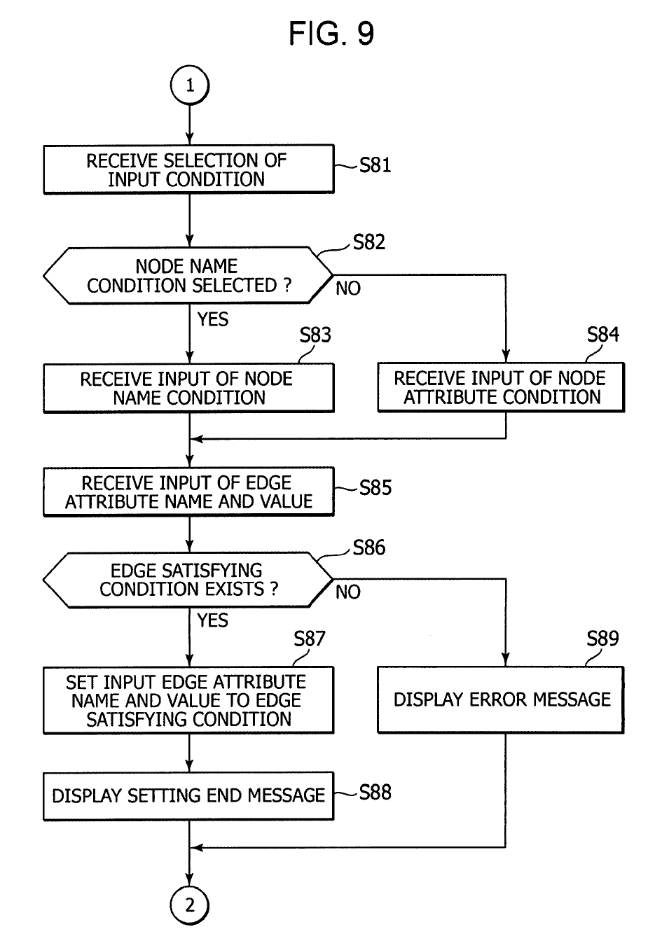

With reference to the flow charts of FIGS. 8 and 9, description will be made on an example of the sequence of the attribute setting process.

As the attribute setting process starts, at Step S71 the attribute setting control unit 104 controls the input unit 51 and output unit 52 to display an attribute setting menu on the monitor and receive a setting selection designation.

The attribute setting menu is a GUI for making a user select setting of either a node attribute or an edge attribute. The user operates the input unit 51 to move a cursor or the like to select setting of either a node attribute or an edge attribute. Based on the setting selection designation input via the input unit 51 in this manner, at Step S72 the attribute setting control unit 104 judges whether the node attribute is to be set.

If it is judged that the node attribute is to be set, the node attribute setting unit 111 of the attribute setting control unit 104 advances the process to Step S73 whereat the node attribute setting unit 111 controls the input unit 51 and output unit 52 to receive a node name condition by displaying on the monitor a GUI for making the user select a node to which an attribute is to be set. This selection method is arbitrary. For example, a list of nodes existing in the graph may be displayed to make a user select one of the nodes, or the user may be made to input a portion or the whole of the node name to select a node whose name is coincident with or contains the input character string. Namely, in this selection, since the user inputs the node name as a condition (filtering condition), a target node can be searched from a plurality of nodes through filtering, even if the identification information can not be grasped completely, or node attributes of a plurality of nodes can be set at a time. Namely, the user can set easily the node attribute of each node, even in a complicated network having a number of nodes.

As the node name condition is input, at Step S74 the node attribute setting unit 111 controls the input unit 51 and output unit 52 to display a GUI for setting an attribute name and an attribute value on the monitor and receive an input of a node attribute name and a node attribute value. The user selected a node adds a new node attribute to the selected node. To this end, the user inputs the node attribute name and node attribute value to be added, by using GUI displayed on the monitor.

Upon reception of an input of the node attribute name and node attribute value, the node attribute setting unit 111 advances the process to Step S75 whereat it is judged whether there exists the node corresponding to the node name condition input at Step S73. If it is judged that the node exists, the process is advanced to Step S76 whereat the data converting unit 22 is controlled to make the data converting unit set the node attribute name and node attribute value input at Step S74 to the node satisfying the condition. After completion of the setting, the node attribute setting unit 111 makes the holding unit 12 hold the graph data 31 added with the node attributes, to thereafter advance the process to Step S77 whereat the output unit 52 is controlled to display a setting end message on the monitor to thereafter terminate the attribute setting process.

If it is judged at Step S75 that the node satisfying the input node name condition does not exist in the graph, the node attribute setting unit 111 advances the process to Step S78 whereat the output unit 52 is controlled to display an error message notifying the user of a failure of attribute settings to thereafter terminate the attribute setting process.

If it is judged at Step S72 that the user selects setting of the edge attribute and does not set the node attribute, the attribute setting control unit 104 advances the process to Step S81 of FIG. 9.

At Step S81 of FIG. 9 the edge attribute setting unit 112 controls the input unit 51 and output unit 52 to receive an input condition selection by the user, by displaying a GUI on the monitor.

Since the edge has no name (although there is a node name, there is no edge name), the user identifies an edge whose attribute is to be set, by using information on the nodes connected to the edge. Namely, the user sets attributes to an edge connected to the node corresponding to the filtering condition. The network analysis assisting apparatus 1 has two types of node information, a node name and a node attribute name, and the edge attribute setting unit 112 makes the user select one of the conditions of the node name and node attribute name.

At Step S82 the edge attribute setting unit 112 judges whether the user selects the node name condition. If it is judged that the node name condition is selected, the process is advanced to Step S83 whereat the input unit 51 and output unit 52 are controlled to receive an input of the node name condition by displaying a GUI on the monitor, to thereafter advance the process to Step S85.

If it is judges at Step S82 that the node name condition is not selected and the node attribute condition is selected, the edge attribute setting unit 112 advances the process to Step S84 whereat the input unit 51 and output unit 52 are controlled to receive an input of the node attribute condition by displaying a GUI on the monitor, to thereafter advance the process to Step S85.

In effect, similar to the case of the node described above, also in the case of the edge, a plurality of edges can be selected at a time. A target edge can be searched in accordance with the filtering condition. Namely, a user can set the edge attribute of each edge even in a complicated network having a number of edges.

Upon reception of the node condition, at Step S85 the edge attribute setting unit 112 controls the input unit 51 and output unit 52 to receive an input of the edge attribute name and edge attribute value to be set to the identified edge to be processed, by displaying a GUI on the monitor.

At Step S86 the edge attribute setting unit 112 judges whether there exists an edge (an edge connected to the node corresponding to the input node condition) corresponding to the condition input in the manner described above. If the corresponding edge exists, the edge attribute setting unit 112 advances the process to Step S87 whereat the data converting unit 22 is controlled to set the input edge attribute name and edge attribute value to the edge corresponding to the condition, and makes the holding unit 12 hold the graph data 31 added with the edge attributes. At Step S88, a setting end message notifying the user of setting end is displayed to thereafter terminate the attribute setting process.

If it is judged at Step S86 that there exists no edge corresponding to the condition, the edge attribute setting unit 112 advances the process to Step 89 whereat the output unit 52 is controlled to display an error message notifying the user of a failure of attribute setting, to thereafter terminate the attribute setting process.

As described above, the network analysis assisting apparatus 1 can set to the graph not only the node attribute but also the edge attribute, i.e., information representative of the meaning of interconnection between elements in the network. Namely, the network analysis assisting apparatus 1 can express not only which node exist in the network and which node is related to which node, but also which node and which node are related in what manner.

For example, if the node is a user and the edge is an interconnection between users, although a related art network can express which users are coupled together or which users are coupled by the what number of times, the related art network cannot express, for example, the type of contents of interconnection. As described above, the network analysis assisting apparatus 1 can set such information as edge attributes. Therefore, the network analysis assisting apparatus 1 can assist more suitable analyses to allow a user to easily analyze the complicated network in various manners.

In the above description, nodes are filtered by a node name condition, and edges are filtered by a node name condition or node attribute name condition. The types of conditions are not limited thereto, but nodes and edges may be filtered by other conditions. For example, node or edge attribute values, the direction of an edge (in the case of a directed graph) and the like may be used as the conditions. A plurality of conditions may be combined.

Since the network is displayed as a graph and attributes are set to nodes and edges as described above when necessary, a user can visually grasp the network and can analyze the network easily. However, a more complicated network is required to be analyzed in recent years. The more complicate the analysis target network is, it becomes more difficult to analyze the network and the importance of assistance increases more. However, with simple representation of a graph, a user cannot analyze sufficiently. Namely, in order to analyze a more complicated network, analyzing methods of more various types are required.

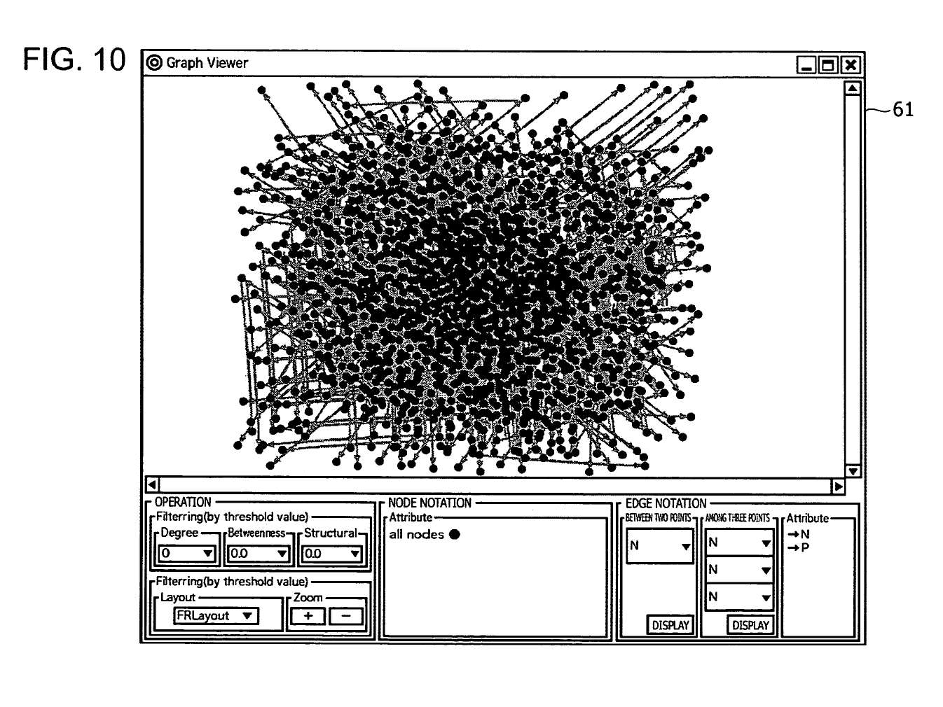

FIG. 10 shows an example of graph display. A graph viewer 61 shown in FIG. 10 displays a complicated graph having nodes and edges more than those of graph display shown in FIG. 2. As the number of nodes and edges increases, node and edges are superposed and the display thereof is crushed, resulting in a fear of difficulty in fine analysis.

If display functions such as magnification and reduction are provided to display a portion of a graph by magnifying it when necessary, it is possible to display nodes and edges without being crushed. However, in this case, in order to grasp the positions and relations of nodes in the whole graph, the relations to other nodes may be unable to be displayed at a time, and the like, so that it is necessary to switch the display areas, resulting in a fear of difficulty in analyses.

The network analysis assisting apparatus 1 is not required to display always all nodes and edges, because the apparatus is intended to assist network analysis and is sufficient if it can present necessary information to a user.

The graph display control unit 105 controls the display control unit 24 to execute a display control process of selecting nodes and edges in a portion of a graph and displaying only the selected nodes and edges. A designation of the display control process is performed in the main menu. As a user selects the display control process in the main menu, the display control process is executed at Step S8 of FIG. 5.

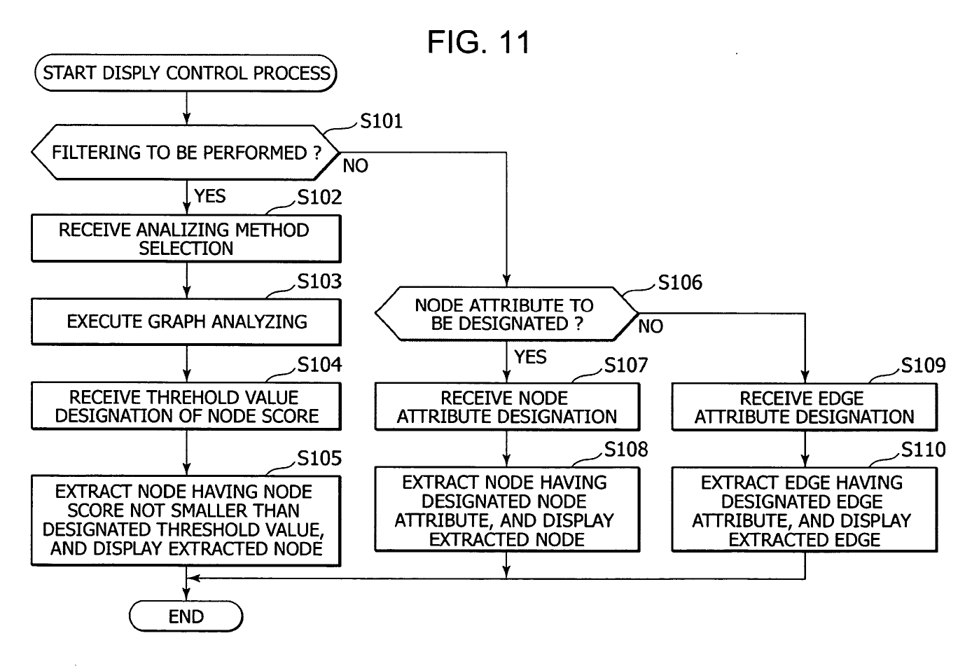

Description will be made on an example of the sequence of the display control process by referring to the flow chart of FIG. 11.

As the display control process starts, at Step S101 the graph display control unit 105 judges whether filtering is performed based on a user designation. The main menu is provided with the selection function of selecting as the display control process, for example, filtering using the analyzed results of a graph, a display designation by the node attribute and a display designation by the edge attribute. As the user selects one of these operations, the display control process is executed. In this selection, at Step S101 the graph display control unit 105 judges whether filtering is selected.

If it is judged that filtering is selected, the graph display control unit 105 advances the process to Step S102. At Step S102 the filtering unit 121 controls the input unit 51 and output unit 52 to display a GUI for selecting an analyzing method to be used in filtering, and to receive a user input from GUI and receive an analyzing method selection by the user. At Step S103 the filtering unit 121 controls the analyzing unit 23 to make the analyzing unit execute graph analysis by the selected analyzing method.

As the graph analysis is completed and analyzed results are obtained, at Step S104 the graph display control unit 105 controls the input unit 51 and output unit 52 to display a GUI for inputting a designation of a threshold value, to be used for filtering, of a node score representative of the value of each node, and to receive a user input from GUI and receive a threshold value designation for the node score.

The node score is an analyzed result obtained through graph analysis, and is a parameter indicating the value of each node to be used for the analyzing method. For example, in analyzing the number of edges connected to each node, the number of edges (or another parameter based on the number of edges) may be used as the node score. Namely, in this case, the value of each node is determined from the number of connected edges. It is obvious that a parameter to be used as the node score may be any item other than the number of edges, and the analyzing method is not limited also.

Although the parameter as the node score and the designating method therefor are arbitrary, the following description will be made on the assumption that the designating method is predetermined for each of the analyzing methods, in the display control process shown in FIG. 11. It is also assumed that the node score operates to delete (not to display) the node having a value smaller than the threshold value designated by the user. Obviously, the node having a value not smaller than the threshold value may be deleted.

As a threshold value designation of a node score is received by the process at Step S104, the filtering unit 121 advances the process to Step S105 whereat the filtering unit controls the display control unit 24 to extract nodes having a node score not smaller than the designated threshold value and edges between these nodes from the graph of the graph data 31, and controls the output unit 52 to display only the extracted nodes and edges on the monitor to thereafter terminate the display control process.

In this manner, the network analysis assisting apparatus 1 can display only the nodes and edges extracted in accordance with the analyzed results. Namely, the network analysis assisting apparatus 1 can delete display of unnecessary information and correctly extract and display only the information necessary for analysis so that it is possible to effectively assist network analyses.

If it is judged at Step S101 that the user does not select and perform filtering, the graph display control unit 105 advances the process to Step S106 to judge whether the node attribute is designated or not. As described above, if it is judged that a display designation of nodes and edges by the node attribute is selected in the main menu, the graph display control unit S105 advances the process to Step S107.

At Step S107 the node attribute selecting unit 122 controls the input unit 51 and output unit 52 to receive a node attribute designation by displaying on the monitor a GUI for designating the node attribute of a node to be displayed, and receiving an input from GUI. Upon reception of the node attribute designation, the node attribute selecting unit 122 advances the process to Step S108 whereat the node attribute selecting unit 122 controls the display control unit 24 to extract nodes having the designated attribute and edges of the nodes, and controls the output unit 52 to display the extracted nodes and edges on the monitor to thereafter terminate the display control process.

In this manner, it becomes possible for a user to designate nodes and edges to be displayed in accordance with the node attribute. For example, there is a case in which analysis is performed by paying attention to a particular node attribute, such as analyzing the distribution and tendency of node attributes in the whole network. In such a case, using the above-described processes, a user can display easily only the nodes (including their edges) having a target node attribute, only by designating a target node attribute, and can delete the display of unnecessary information. Namely, since the network analysis assisting apparatus 1 can delete the display of unnecessary information and can correctly extract and display only information necessary for analysis, analyzing a network can be assisted effectively.

As described above, if it is judged at Step S106 that the user selects in the main menu neither the filtering nor the node attribute designation, and selects a display designation of nodes and edges in accordance with the edge attribute, the graph display control unit S105 advances the process to Step S109.

At Step S109 the edge attribute selecting unit 123 controls the input unit 51 and output unit 52 to receive an edge attribute designation by displaying on the monitor a GUI for designating the edge attribute of an edge to be displayed, and receiving an input from GUI. Upon reception of the edge attribute designation, the edge attribute selecting unit 123 advances the process to Step S110 whereat the edge attribute selecting unit controls the display control unit 24 to extract edges having the designated attribute and nodes connected to the edges, and controls the output unit 52 to display only the extracted nodes and edges (deleting the other nodes and edges) on the monitor to thereafter terminate the display control process.

In this manner, it becomes possible for a user to designate nodes and edges to be displayed in accordance with the edge attribute. Namely, the network can be analyzed in accordance with the edge attribute, i.e., the meaning of interconnection of nodes.

For example, in a network showing the usage results of speech services of telephone or the like, a user is used as a node, the usage fact of speech services is used as an edge, and a usage time zone is used as an edge attribute. Even if a display designation of nodes and edges is performed in accordance with the node attribute in a related art manner, a user cannot grasp the distribution of usage states in terms of gender, age or the like. Even if a display designation of nodes and edges is performed by the node attribute using an edge frequency, i.e., the number of speeches, the user cannot grasp the distribution of usage frequency of the services.

In contrast, as described above, by performing a display designation of nodes and edges in accordance with the edge attribute, a user can grasp the distribution of usage time zones of the services, and can analyze the time zone and the number of speeches of each user. With this analysis, for example, a user can propose such as enhancing usage of the service by reducing a phone toll in the time zone having a large usage frequency.

In the above description, the display control is conducted from the main menu. For example, as shown in FIG. 10, a user may select a node of a graph displayed in the graph viewer 61 to display only a portion regarding the node (delete a portion irrelevant to the node).

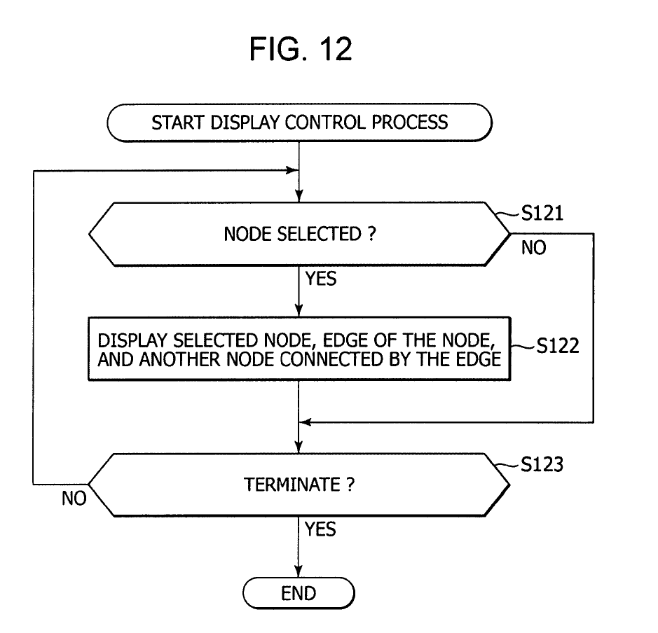

With reference to the flow chart of FIG. 12, description will be made on an example of the sequence of the display control process to be executed in this case. This process is executed while a graph is displayed in the graph viewer 61.

As the display control process starts, at Step S121 the graph display control unit 105 judges whether a node is selected in the graph displayed in the graph viewer. If it is judged that the user selects a node, the graph display control unit 105 advances the process to Step S122 whereat the graph display control unit controls the display control unit 24 to extract the selected node, edges of the node, and other nodes connected to the edges from the graph and display only the selected ones on the monitor. Namely, only the node selected by the user and the interconnection destinations of the node, and edges are displayed, and the other nodes and edges are deleted.

After completion of the display, the graph display control unit 105 advances the process to Step S123. If it is judged at Step S121 that a node is not selected, the graph display control unit 10f5 advances the process to Step S123 without executing the process at Step S122. At Step S123 the graph display control unit 105 judges whether the display control process is to be terminated. If it is judged that the graph is still displayed in the graph viewer 61 and the display control process is not to be terminated, the process is returned to Step S121 to repeat the succeeding processes. If it is judged at Step S123 that graph display is terminated and the display control process is to be terminated, the graph display control unit 105 terminates the display control process.

With this display control, a user can easily display a node interconnection state, for example, merely by selecting a desired node in the displayed graph, and can grasp easily the state of a particular node so that the network can be analyzed properly. The network analysis assisting apparatus 1 can therefore assist various analyses by a user.

The network analysis assisting apparatus 1 can also assist analyses of a network by a user by analyzing the network and supplying the analyzed results to the user.

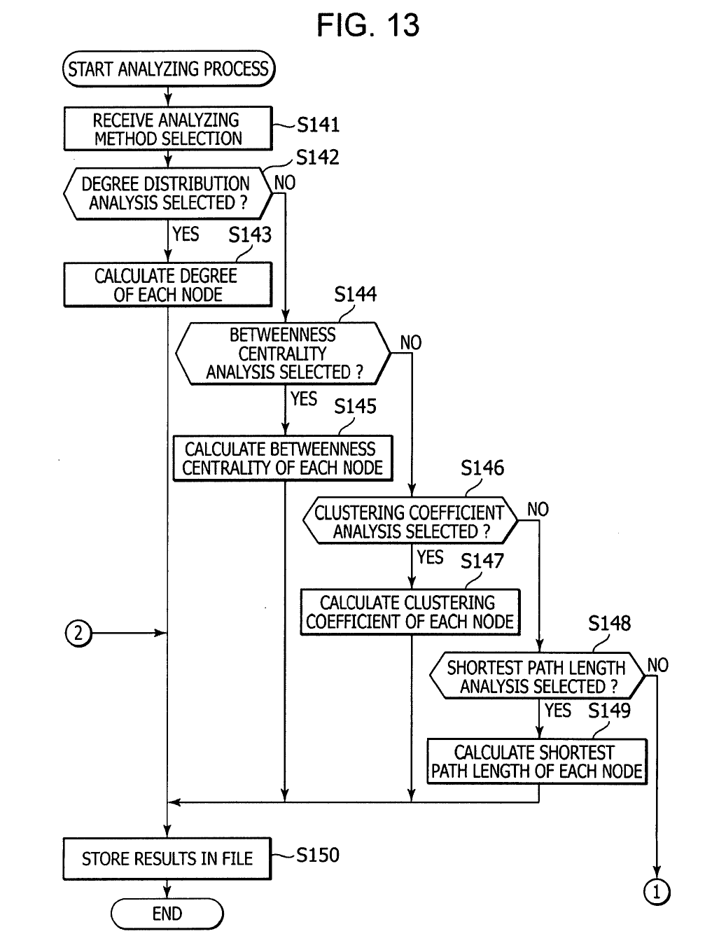

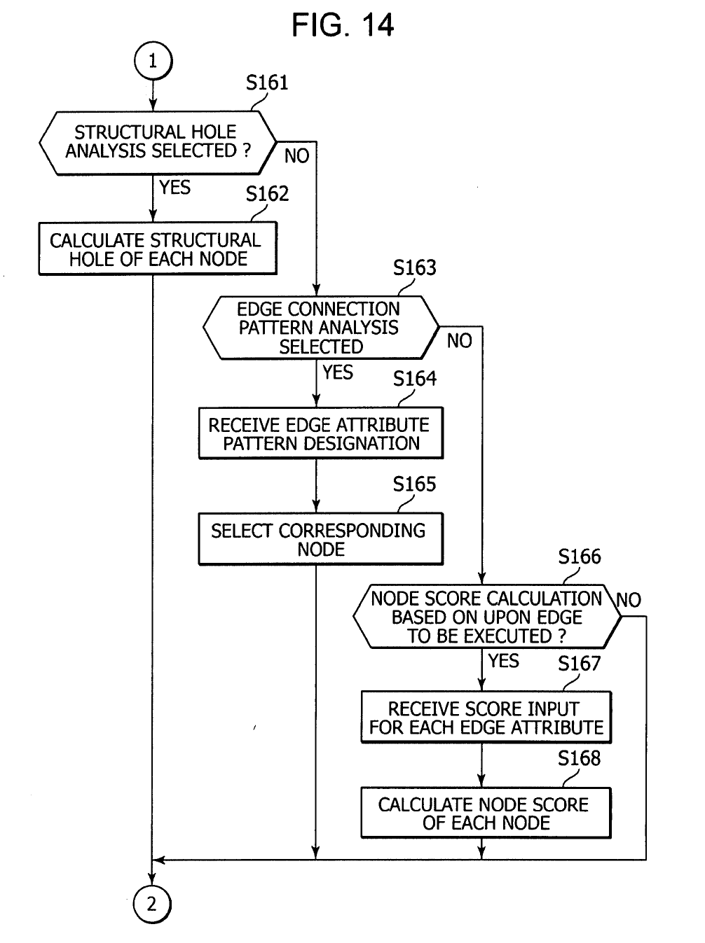

With reference to the flow charts of FIGS. 13 and 14, description will be made on an example of the sequence of the analyzing process.

As a user selects the analyzing process, for example, in the main menu, the analyzing process is executed at Step S8 of FIG. 5.

As the analyzing process starts, at Step S141 the graph analyzing control unit 104 (FIG. 4) controls the input unit 51 and output unit 52 to receive an analyzing method selection by displaying on the monitor a GUI for making a user select a specific analyzing method and receiving an input from GUI.

Prepared beforehand as the analyzing method are: degree distribution analyzing for calculating a degree of each node in order to analyzing the distribution in a network of the number (degree) of edges connected to one node; betweenness centrality analyzing for obtaining a betweenness centrality of each node representative of an influence degree upon other nodes; clustering coefficient analyzing for calculating a clustering coefficient of each node to analyze the distribution of the intensity of interconnection between arbitrary nodes, the clustering coefficient indicating an existence possibility of an edge interconnecting arbitrary two nodes in a network; shortest path length analyzing for obtaining the shortest path length of each node to analyze the distribution of the intensity of interconnection between nodes; structural hole analyzing for obtaining a structural hole of each node to obtain weakness of interconnection between nodes; edge designation analyzing for selecting a node in accordance with an edge connection pattern; and first score analyzing for calculating a node score in accordance with an edge score value. A user selects one of these analyzing methods to execute the analyzing process.

At Step S142 the graph analyzing control unit 106 judges whether the degree distribution analyzing is selected. If it is judged that this analyzing is selected, the process is advanced to Step S143. At S143 the degree analyzing unit 131 controls the analyzing unit 23 to calculate the degree of each node. Upon completion of the process at Step S143, the degree analyzing unit 131 advances the process to Step S150.

If it is judged at Step S142 that the degree distribution analyzing is not selected, the graph analyzing control unit 106 advances the process to Step S144 whereat it is judged whether the betweenness centrality analyzing is selected. If it is judged that this analyzing is selected, the process is advanced to Step S145. At Step S145 the betweenness centrality analyzing unit 132 controls the analyzing unit 23 to calculate the betweenness centrality of each node.

The betweenness centrality is a parameter representative of an influence ratio of a node influencing the relation between other nodes. More specifically, the betweenness centrality of one node in a network is a parameter indicating a magnitude of a ratio of the shortest path passing the node, the shortest path extending along an edge between other two arbitrary nodes. For example, even a node A having a large degree is deleted, if there exists a node B connected to other nodes in quite the same manner as the node A, there is a high possibility that the node B becomes an substitute of the node A and a possibility that the node A does not influence greatly the whole network. However, for example, if the one and only node C interconnecting two node groups each formed from different nodes is deleted, the relation between the two node groups is disconnected, even if the node C has a low degree. The node C has a high possibility of influencing greatly the whole network, and is an important node for the network. The betweenness centrality is a parameter representative of such importance.

More specifically, a content betweenness centrality Ce (nᵢ) of a fixed node nᵢ can be calculated from the following formula (1):

$$Ce ( {n}_{i} ) \frac{{\sum }_{s < t} {g}_{i}^{( st )} / {n}_{st}}{\frac{1}{2} n ( n - 1 )} \qquad ( 1 )$$

In the formula (1), n represents the number of pairs of two nodes other than the target node nᵢ, nₛₜ represents the number of paths having the shortest path length (shortest paths) between nodes s and t other than the node nᵢ, and gⱼ^{(st)} represents the number of paths passing through the node nᵢ among nₛₜ. The value s is smaller than the value t.

Namely, the content betweenness centrality Ce(nᵢ) of the node nᵢ is an average of ratios of shortest paths between all combinations of the nodes s and t passing through the node nᵢ.

After completion of the process at Step S145, the betweenness centrality analyzing unit 132 advances the process to Step 150.

If it is judged at Step S144 that the betweenness centrality analyzing is not selected, the graph analyzing control unit 106 advances the process to Step S146 whereat it is judged whether the clustering coefficient analyzing is selected. If it is judged that this analyzing is selected, the process is advanced to Step S147. At Step S147 the clustering coefficient analyzing unit 133 controls the analyzing unit 23 to calculate the clustering coefficient of each node.

The analyzing unit 23 calculates the number of connected node pairs among all node pairs connected to the node nᵢ. Namely, the analyzing unit 23 obtains a clustering coefficient C(nᵢ) of each node by calculating the following formula (2):
C(nᵢ)=No. of connected pairs/No. of all pairs (2)

After completion of the process at Step S147, the clustering coefficient analyzing unit 133 advances the process to Step 150.

If it is judged at Step S146 that the clustering coefficient analyzing is not selected, the graph analyzing control unit 106 advances the process to Step S148 whereat it is judged whether the shortest path length analyzing is selected. If it is judged that this analyzing is selected, the process is advanced to Step S149. At Step S149 the shortest path length analyzing unit 134 controls the analyzing unit 23 to calculate the shortest path of each node.

After completion of the process at Step S149, the shortest path length analyzing unit 134 advances the process to Step S150.

At Step S150 the graph analyzing control unit 106 stores the calculated analyzed results in the analyzed data file 44 to be stored in the storage unit 13 to thereafter terminate the analyzing process.

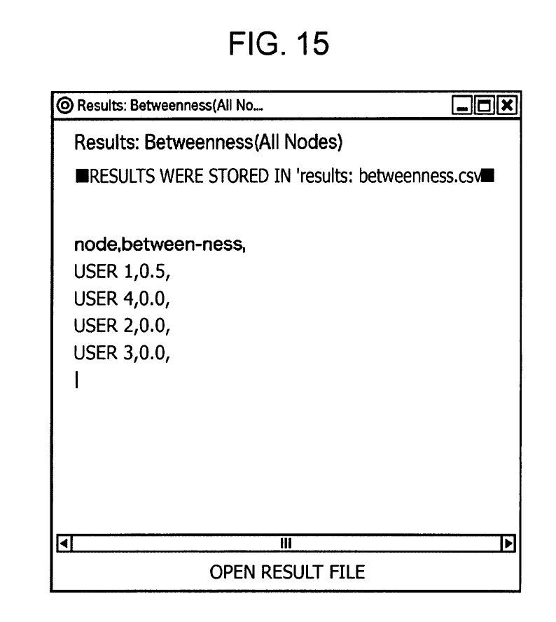

FIG. 15 is a diagram showing an example of the analyzed results. As shown in FIG. 15, the analyzed results are listed, e.g., filed as a CSV file, and recorded in the storage unit 13 as the analyzed data file 44.

If it is judged at Step S148 shown in FIG. 13 that the shortest path length analyzing is not selected, the graph analyzing control unit 106 advances the process to Step S161 shown in FIG. 14.

At Step S161 of FIG. 14, the graph analyzing control unit 106 judges whether the structural hole analyzing is selected. If it is judged that this analyzing is selected, the process is advanced to Step S162. At Step S162 the structural hole analyzing unit 135 controls the analyzing unit 23 to calculate an efficiency of each node for the structural hole. Namely, the analyzing unit 23 obtains an effective size of each node from the following formula (3), and obtains an efficiency from the following formula (4) by using the effective size:
ESᵢ=Eᵢ−Σₑ_{ᵢ}[{fᵢ(nⱼ,nₖ),i!=k}/Eᵢ] (3)
Efficiency=ESᵢ/Eᵢ (4)

In the formula (3), ESᵢ represents an effective size of a node nᵢ, Eᵢ represents a total number of edges connected to the node nᵢ, and fᵢ(nⱼ, nₖ) represents a function which takes a value “1” if the node nⱼ or node nₖ has an edge, and a value “0” if the node nⱼ or node nₖ does not have an edge.

After completion of the process at Step S162, the structural hole analyzing unit 135 returns the process to Step S150 of FIG. 13.

If it is judged at Step S161 of FIG. 14 that the structural hole analyzing is not selected, the graph analyzing control unit 106 advances the process to Step S163 whereat it is judged whether the edge connection pattern analyzing is selected. If it is judged that this analyzing is selected, the process is advanced to Step S164.

The edge attribute pattern analyzing is a process of receiving a designation of the edge attribute and extracting a node group interconnected by edges having the designated edge attribute, from the network. In this case, a user can designate a plurality of edges, i.e., a distribution pattern of edges (in other words, a distribution pattern of the edge attribute), by designating a plurality of edge attributes. Namely, the edge attribute pattern analyzing extracts from the network a node group whose edge attribute distribution pattern is connected to edges having features designated by the user. More specifically, the edge attribute pattern analyzing can extract from a network a node group having a fixed relation designated by the user.

At Step S164 the edge designation analyzing unit 136 controls the input unit 51 and output unit 52 to receive an edge attribute distribution pattern designation by displaying on the monitor a GUI for making a user input an edge attribute distribution pattern designation, and receiving an edge attribute distribution pattern designation. Upon reception of the edge attribute pattern designation from the user, the edge designation analyzing unit 136 advances the process to Step S165, and controls the analyzing unit 23 to obtain a node pair corresponding to the designated edge attribute pattern.

For example, if a user designates one edge attribute, the edge designation analyzing unit 136 controls the analyzing unit 23 to select two nodes connected to the edge. Further, for example, if three nodes are to be selected, a user designates three types of edge attributes.

A network may have a plurality of node groups whose edges have a common feature. For example, a resident in some district is used as a node, and its blood relations are used as an edge (a specific relation is used as an edge attribute). In this case, assuming that there are a plurality of families of the same configuration, a plurality of node groups exist in a network, having a similar pattern of the relation (edge attribute) between nodes.

In this manner, a user can grasp the feature of a node distribution in accordance with the meaning of interconnection between nodes. For example, a user can extract node groups having a specific relation pattern or classify nodes into each pattern. Further, in accordance with such analysis results, the user can perform more sophisticated analyses such as analyzing the effect to be obtained when a service providing method is changed between large families and nuclear families.

As the node group is selected in this manner, the edge designation analyzing unit 136 returns the process to Step S150 of FIG. 13.

If it is judged at Step S163 of FIG. 14 that the edge connection pattern analyzing is not selected, the graph analyzing control unit 106 advances the process to Step S166 whereat it is judged whether a node score calculation is performed based on an edge. If it is judged that the calculation is to be preformed, the process is advanced to Step S167. At Step S167 the first score analyzing unit 137 controls the input unit 51 and output unit 52 to receive a score input for each edge attribute (an input of weight of the edge attribute of an edge), by displaying on the monitor a GUI for inputting a score of each edge attribute, and receiving an input to GUI. Upon reception of the score input, at Step S168 the first score analyzing unit 137 controls the analyzing unit 23 to calculate a node score (node weight) of each node in accordance with the input score.

After completion of the node score calculation, the first score analyzing unit 137 returns the process to Step S150 of FIG. 13.

If it is judged at Step S166 of FIG. 14 that the node score calculation on the basis of the edge is not performed, the graph analyzing control unit 106 returns the process to Step S150 of FIG. 13 without executing the analyzing process.

As described above, the network analysis assisting apparatus 1 has beforehand various analyzing methods, can perform various analyses by using these analyzing methods, and can assist various analyses by providing a user with the analyzed results.

In the above description, analysis is performed in response to a user designation in the main menu. Processes fundamentally similar to those described above are executed in other cases, for example, in the analyzing process at Step S58 of FIG. 7 and Step S103 of FIG. 11. In these cases, however, instead of filing and storing the analyzed results at Step S150, for example, the analyzed results may be displayed on the monitor or used for the display control process. Further, for example, the analyzed results may be displayed and output, and filed and stored.

Although the analyzing methods have been described illustratively, analysis may be made by other methods. For example, in a network in which a node score of a node influences a node score of another node connected to the node via an edge, in order to correctly analyze the state of this influence, the analyzing method may be adopted by which the node score of the node is calculated by using the node score of the other node.

For example, a node score of each of three nodes interconnected by edges is calculated by using node scores of the two other nodes.

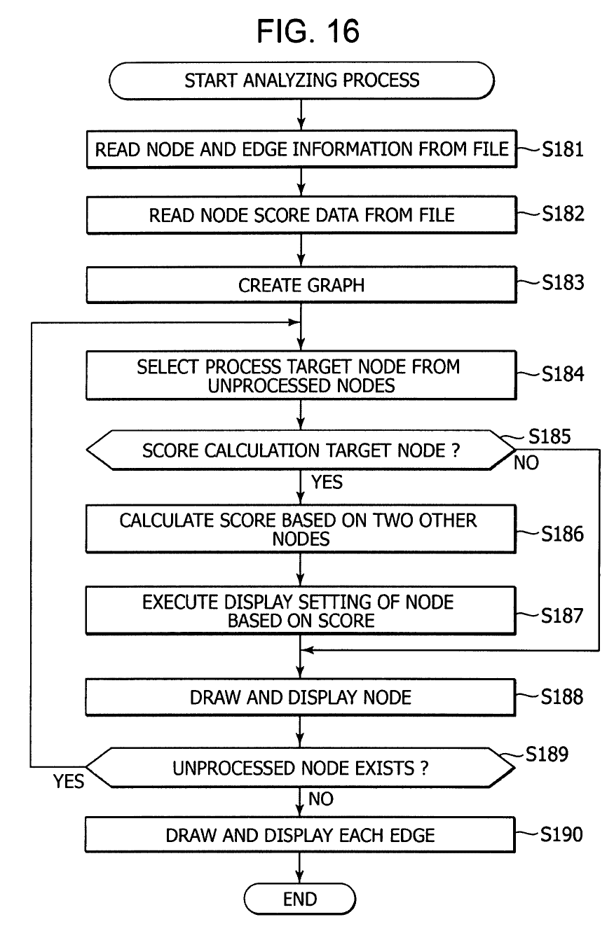

With reference to the flow chart of FIG. 16, description will be made on an example of the sequence of this analyzing process. For example, as a user selects the analyzing process in the main menu and the analyzing process starts, at Step S181 the second score analyzing unit 138 controls the read unit 26 to read the node information and edge information from the network file 41 to edge attribute file 43 stored in the storage unit 13. At Step S1182 the second score analyzing unit controls the read unit 26 to read the existing node score data from the analyzed data file 44 stored in the storage unit 13, and at Step S183 controls the data converting unit 22 to create a graph in accordance with the read data.

At Step S184 the second score analyzing unit 138 selects a target node for process from unprocessed nodes, and judges at Step S185 whether the selected node is a score calculation target node. For example, the second score analyzing unit 138 judges whether the process target node is in a three-node connection.

If it is judged that the process target node is a node in the three-node connection and a score calculation target node, the second score analyzing unit 138 advances the process to Step S186, and controls the analyzing unit 23 to calculate a score in accordance with the node scores of the two other nodes. A score calculation method is determined beforehand. A specific example of score calculation will be later described. After the score calculation, at Step S187 the second score analyzing unit 138 performs display settings of the node in accordance with the score value, and advances the process to Step S188. If it is judged at Step S185 that the process target node is not in the three-node connection and is not a score calculation target node, the second score analyzing unit 138 advances the process to Step S188.

At Step S188 the second score analyzing unit 138 draws and displays the score-calculated node. At Step S189 the second score analyzing unit 138 judges whether there is an unprocessed node. If it is judged that there is an unprocessed node, the process is returned to Step S184 to execute the succeeding processes for the next unprocessed node.

If it is judged at Step S189 that there is an unprocessed node, the second score analyzing unit 138 advances the process to Step S190 whereat each edge is drawn and displayed to thereafter terminate the analyzing process.

In this manner, the second score analyzing unit 138 calculates a node score of each node by using the node scores of the two other nodes in the three-node connection.

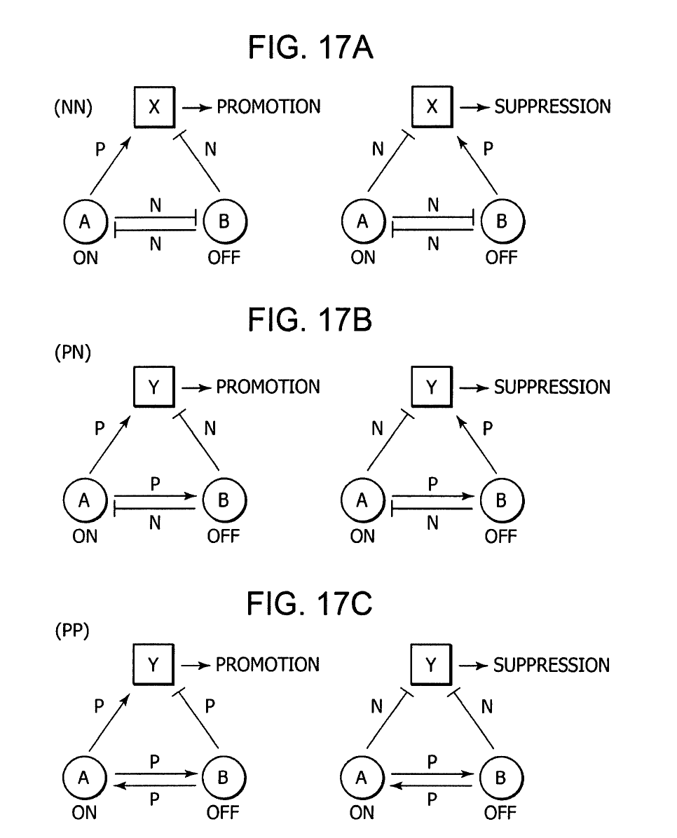

Next, with reference to FIGS. 17(A) to 17(C), description will be made on specific examples of node score calculation.

FIGS. 17(A) to 17(C) are diagrams explaining examples of node score calculation for estimation of the relation between the two-molecule relation state of a molecule set, and a cell function. This network model is a model for representing the relation between a mutual action between molecules of protein and a cell function by numerical values, and analyzing the relation. For example, this model is used for analyzing protein information in medical fields or the like, such as analyzing the manifestation amount of detection target molecules (protein) in a cell.

Models shown in FIGS. 17(A) to 17(C) are network models for estimating the relation between a molecule set including a protein A and a protein B, and a cell function X. These network models use the protein A, protein B and cell function as a node, and the relation among the protein A, protein B and cell function as an edge. Namely, the cell function is in the three-node connection relative to the protein A and protein B.

It is assumed that the models are classified into an NN type, a PN type, a PP type, a P type and an N type, from the viewpoint of whether the combination state (two-molecule relation state) of two molecules of the protein A and protein B promotes or suppresses the other molecule. This classification represents an edge attribute.

The NN type is a suppression combination of two molecules of the protein A and protein B. If one of a combination of NN type two molecules is superior to the other in terms of quantity or function, a molecule switch function appears, one being “ON” and the other being “OFF”. The PN type represents a combination of one promoting the other and the other suppressing one. If two molecules have different functions of promotion and suppression, information on the promoting side converges to a constant value through oscillation by negative feedback. The PP type represents a combination of both promoting the other. Namely, if each of two molecules promotes the other, information on both the molecules is amplified by positive feedback.

Although description is omitted in FIGS. 17(A) to 17(C), the P type is a combination of only one promoting the other, and the N type is a combination of only one suppressing the other.

FIG. 17(A) shows models for estimating the relation between the two-molecule relation sate in a molecule set of the NN type, and a cell function. In this case, if a node score of one protein of the molecule set is larger than that of the other, the node attribute of one protein is “ON”, and if smaller conversely, the node attribute is “OFF”. Whether the molecule set of the NN type is promotive (POS) or suppressive (NEG) relative to the cell function X depends upon the connection state between the cell function X to the protein having the node attribute of “ON”. Namely, if a connection between the protein having the node attribute “ON” and the cell function X is P, it means promotion, whereas if N, it means suppression. In the examples shown in FIG. 17(A), since the node attribute of the protein A is “ON”, if the connection of the protein A to the cell function X is P, i.e., in the left example in FIG. 17(A), the molecule set of the NN type promotes the cell function X. Conversely, if the connection of the protein A to the cell function X is N, i.e., in the right example in FIG. 17(A), the molecule set of the NN type suppresses the cell function X.

In estimating the relation between the molecule set of the NN type and the cell function, the second score analyzing unit 138 (FIG. 4) calculates at Step S186 in FIG. 16 a node score SX of the cell function X from the following formula (5) for promotion and from the following formula (6) for suppression:
SX=|A−B|×α (5)
SX=−|A−B|×α (6)

In the formulas (5) and (6), α is a constant, A is a node score of the protein A, and B is a node store of the protein B.

FIG. 17(B) shows models for estimating the relation between the two-molecule relation state in a molecule set of the PN type, and a cell function. In this case, if a promotion function is give from the protein A to the protein B (if a connection from the protein A to the protein B is a P connection and a connection from the protein B to the protein A is an N connection), and if there exists a cell function Y which receives a promotion (P) function from the protein A “ON” and a suppression (N) function from the protein B “OFF”, the PN type molecule set is considered to be promotive (POS) relative to the cell function Y. Similarly, if there exists a cell function Y which receives a suppression (N) function from the protein A “ON” and a promotion (P) function from the protein B “OFF”, the PN type molecule set is considered to be suppressive (NEG) relative to the cell function Y.

In estimating the relation between the molecule set of the PN type and the cell function, the second score analyzing unit 138 (FIG. 4) calculates at Step S186 in FIG. 16 a node score SY of the cell function Y from the following formula (7) for promotion and from the following formula (8) for suppression:
SY=A×β (7)
SY=B×β (8)

In the formulas (7) and (8), β is a constant, A is a node score of the protein A, and B is a node store of the protein B.

FIG. 17(C) shows models for estimating the relation between the two-molecule relation state in a molecule set of the PP type, and a cell function. In this case, if both the connections of the protein A and protein B to the cell function Y are a P connection promotion), the PP type molecule set is considered promotive (POS) relative to the cell function Y Similarly, if both the connections of the protein A and protein B to the cell function Y are an N connection (suppression), the PP type molecule set is considered suppressive (NEG) relative to the cell function Y.

In estimating the relation between the molecule set of the PP type and the cell function, the second score analyzing unit 138 (FIG. 4) calculates at Step S186 in FIG. 16 a node score S_{Y} of the cell function Y from the following formula (9) only for promotion, by using node scores of the protein A and protein B:
SY=A×B×γ (9)

In the formula (9), γ is a constant, A is a node score of the protein A, and B is a node store of the protein B.

In this manner, the second score analyzing unit 138 can calculate a node score by using the node scores of the two other nodes constituting the three-node connection. The network analysis assisting apparatus 1 can therefore deal with sophisticated analyses such as estimating the relation between the protein molecule set and cell function described above. By using the network analysis assisting apparatus 1, a user can analyze easily even a complicated network in which a node score of each node influences a node score of another node.

The above-described examples are only illustrative, and node score calculation by using the node scores of the two other nodes forming the three-node connection may be applied to any other cases.

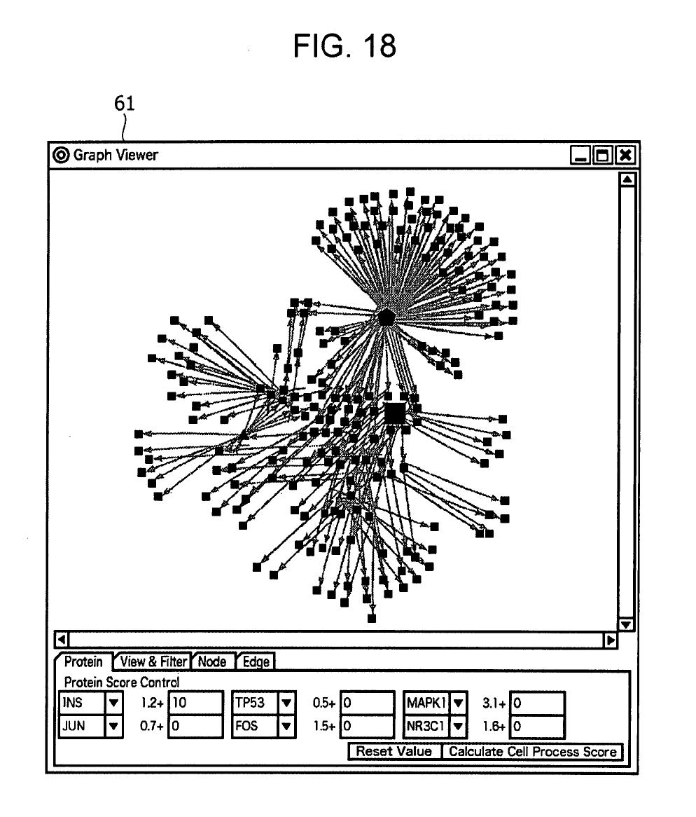

By executing various processes such as the display control process and analyzing process described above, even for a large scale and complicated network otherwise unable to be analyzed such as shown in FIG. 10, only necessary information can be obtained and displayed such as shown in FIG. 18. Therefore, a user can easily grasp the features and tendencies of a network by using the network analysis assisting apparatus 1.

In the example shown in FIG. 18, the network is displayed so as to grasp the tendency that edges are concentrated upon which node, more easily than the case shown in FIG. 10. In the example shown in FIG. 18, for example, the display size of each node may be designated in an operation area 63 of a graph viewer 61, to increase the size of a node to emphasize an important node on which edges are concentrated, or to change the color and shape.

In the example shown in FIG. 16, although a graph is created and analyzed, a node score of each node may be changed in the operation area 63 of the graph viewer 61 shown in FIG. 18. In this case, in a network in which a node score of one node influences a node score of another node such as in the three-node connection, it becomes necessary to calculate again the node score of each node in the whole network.

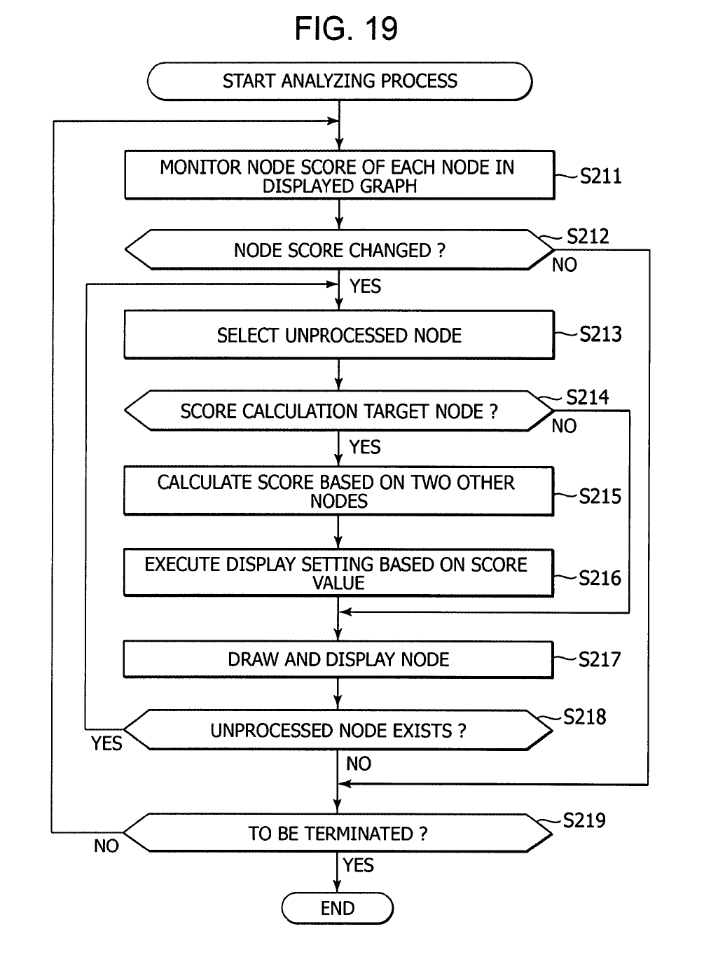

With reference to the flow chart of FIG. 19, description will be made on an example of the sequence of this analyzing process.

As the graph is displayed and the analyzing process starts, at Step S211 the score updating unit 139 controls the input unit 51 and output unit 52 to monitor of a node score of each node in the displayed graph. At Step S212 the score updating unit 139 judges whether there is a change in the node score of any one of the nodes. If it is judged that there is a change in the node score because of, e.g., a user input, the process is advanced to Step S213 whereat calculation starts again for node scores of all nodes (or some nodes).

The score updating unit 139 controls the analyzing unit 23 to select a node still not processed as Step S213 as a target node for process, and judges at Step S214 whether the process target node corresponds to a score calculation target node whose node score is required to be calculated again. If it is judged that the process target node is the score calculation target node whose node score is required to be calculated again, at Step S215 the score updating unit 139 controls the analyzing unit 23 to make the analyzing unit calculate the node score of the process target node by using the node scores of the two other nodes in the three-node connection constituted by the process target node. As the node score is calculated, the score updating unit 139 controls the display control unit 24 to perform display setting of the process target node such as determining the display size, in accordance with the calculated node score value. After completion of the display setting, the score updating unit 139 advances the process to Step S217.

If it is judged at Step S214 that the process target node is not the score calculation target node, the score updating unit 139 omits the processes at Steps S215 and S216 to advance the process to Step S217.

At Step S217 the score updating unit 139 controls the output unit 52 to draw and display the process target node. At Step S218 the score updating unit 139 judges whether there is any unprocessed node. If it is judged that there exists an unprocessed node, the process is returned to Step S213 to repeat the succeeding processes for the unprocessed node. If, for example, all nodes in the network have been processed and it is judged at Step S218 that there is no unprocessed node, the score updating unit 139 advances the process to Step S219. If it is judged at Step S212 that there is no change in the node score of any node, the score updating unit 139 judges whether the analyzing process is to be terminated. If it is judged that the analyzing process is not to be terminated, the score updating unit 139 returns the process to Step S211 to repetitively execute the succeeding processes. If, for example, the graph display is terminated and it is judged that the analyzing process is to be terminated, the score updating unit 139 terminates the analyzing process.

Since the network analysis assisting apparatus 1 can update a node score in this manner, for example a user can change the node scores of some nodes in the network, and can perform sophisticated analyses such as checking the influence of a change in the node score upon the whole network. Since the network analysis assisting apparatus 1 can provide a user with the latest state of the network, a more proper analysis assistance is possible.

As a user selects a holding process in the main menu, the latest graph data 31 updated in the above manner can be held in the file. Upon reception of a graph holding designation, the graph holding control unit 107 starts the holding process, converts the graph data into a file, and stores the file in the storage unit 13.

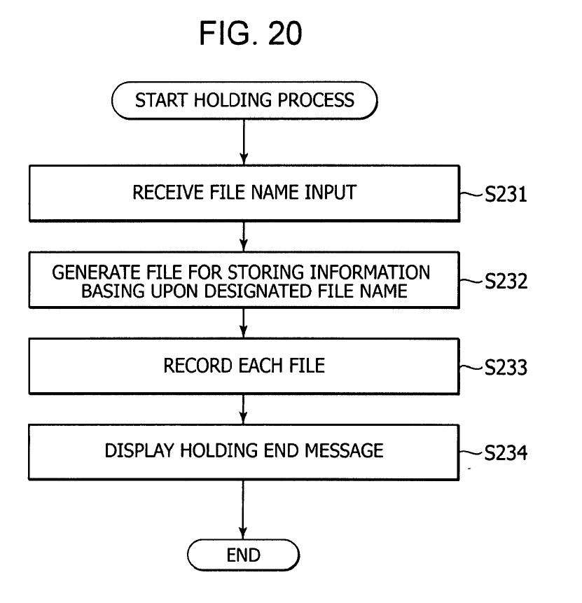

With reference to the flow chart of FIG. 20, description will be made on an example of the sequence of the holding process.

As the holding process starts, at Step S231 the graph holding control unit 107 controls the input unit 51 and output unit 52 to receive a file name input from a user, by displaying on the monitor a GUI for making a user enter a file name and receiving an input to GUI.

At the file name input is received, at Step S232 the graph holding control unit 107 controls the data converting unit 22 to convert the graph data 31 into a file for storing each information (network file 41, node attribute file 42, edge attribute file 43, analyzed data file 44 and the like), in accordance with the designated file name.

At Step S233 the graph holding control unit 107 controls the write unit 25 to record each generated file in the storage unit 13. After completion of recording the file, at Step S234 the graph holding control unit 107 controls the output unit 52 to display a holding completion message notifying a user of holding completion to thereafter terminate the holding process.

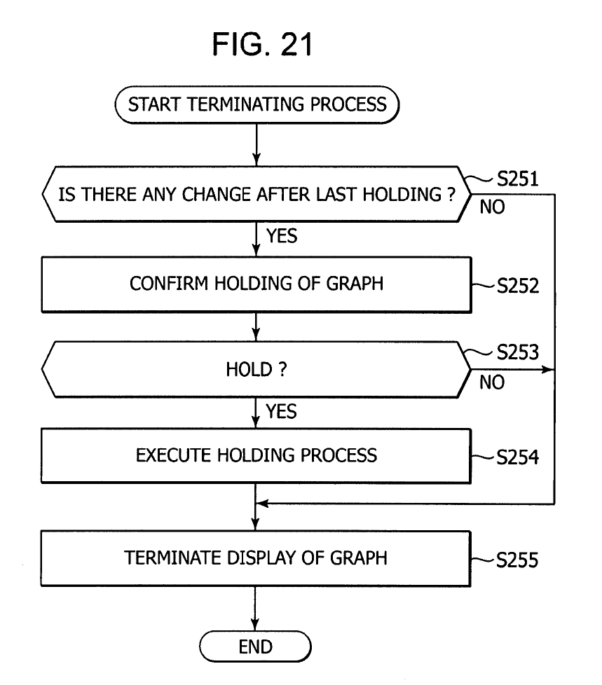

When the user selects the termination process in the main menu, the termination process control unit 108 executes the termination process to terminate graph display. With reference to the flow chart of FIG. 21, description will be made on an example of the sequence of the termination process.

As the termination process starts, at Step S251 the termination process control unit 108 judges whether the graph data 31 was changed because of the analyzing process, attribute setting process or the like executed after the last (latest) holding. If it is judged that the graph data was changed, the process is advanced to Step S252 whereat the input unit 51 and output unit 52 are controlled to confirm graph holding by displaying a GUI for making a user to enter whether the graph is to be held and receiving an input to GUI. Upon reception of a user designation, the termination process control unit 108 advances the process to Step S253 whereat it is judged from the user designation whether the graph is to be held or not. If it is judged that the graph is to be held, the process is advanced to Step S254 whereat the termination process control unit 108 controls the graph holding control unit 107 to execute the holding process. After completion of the holding process, at Step S255 the termination process control unit 108 terminates graph display to thereafter terminate the termination process.

If it is judged at Step S251 that the graph was not changed after the last holding, or if the user designates not to hold the graph at Step S253, the termination process control unit 108 advances the process to Step S255 whereat the output unit 52 is controlled to terminate graph display to thereafter terminate the termination process.

As described above, the network analysis assisting apparatus 1 allows a user to define the attribute of not only the node but also the edge to thereby facilitate a network analysis and provide a variety of analyses by using the attributes.

In the above description, although only one network analysis assisting apparatus 1 is used, a network system may be realized by using a plurality of apparatus having the structure shown in FIG. 1 and interconnected via a network.

For example, although the network file 41 and the like are stored in the storage unit 13 in FIG. 1, these files may be acquired from a server or the like via a network.

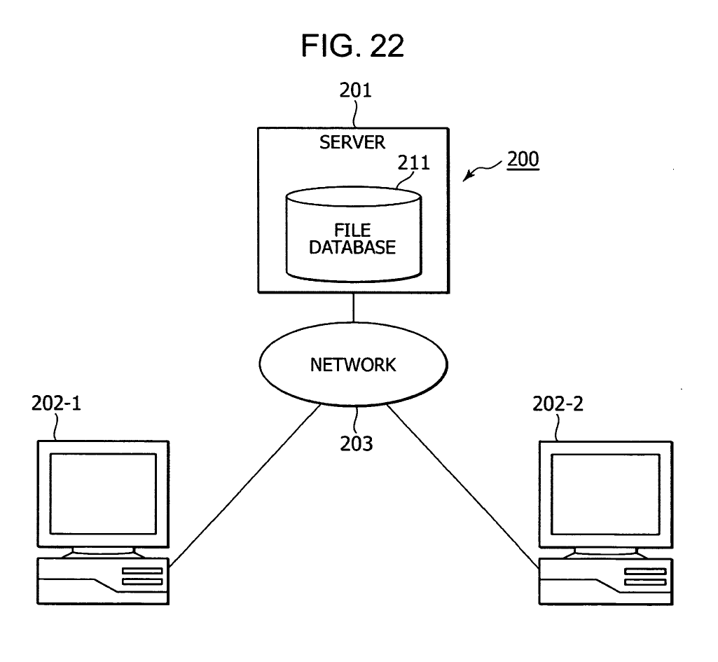

FIG. 22 is a diagram showing another embodiment of the present invention. In FIG. 22, a network analysis assisting system 200 is a network system including a server 201, a client 202-1 and a client 202-2 interconnected via a wired or wireless network 203 typically a LAN and the Internet. The network analysis assisting system is a system for assisting an analysis of a network formed from nodes and edges, to be performed by users of the clients 202-1 and 202-2. In the following, if the clients 202-1 and 202-2 are not necessary to be distinguished, the clients are simply called a client 202.

The server 201 has a file database 211 for registering the network file 41 to analyzed data file 44. A file generated by the client 202 is registered in the file database 211 and managed collectively.

Although the client 202 has basically the same structure as that of the network analysis assisting apparatus 1 shown in FIG. 1, the network file 41 to analyzed data file 44 are not stored in the storage unit 13, but supplied to the server 201 and registered in the file database 211. Therefore, also in reading a file, the client 202 accesses the server 201 via the network 203 and acquires a necessary file from the file database 211.

With this arrangement, the files can be shared by each client 202.

In the network analysis assisting system 200 shown in FIG. 22, the number of servers 201, client 202 and networks 203 are arbitrary, and other structures may be included.

It is sufficient if the server 201 and client 202 can realize the processes to be executed by the network analysis assisting apparatus shown in FIG. 1, and it is arbitrary that which process is executed at which component. For example, the client 202 may execute only the user interface process such as image display and input reception, and the server 201 may execute each process such as a data converting process and an analyzing process.

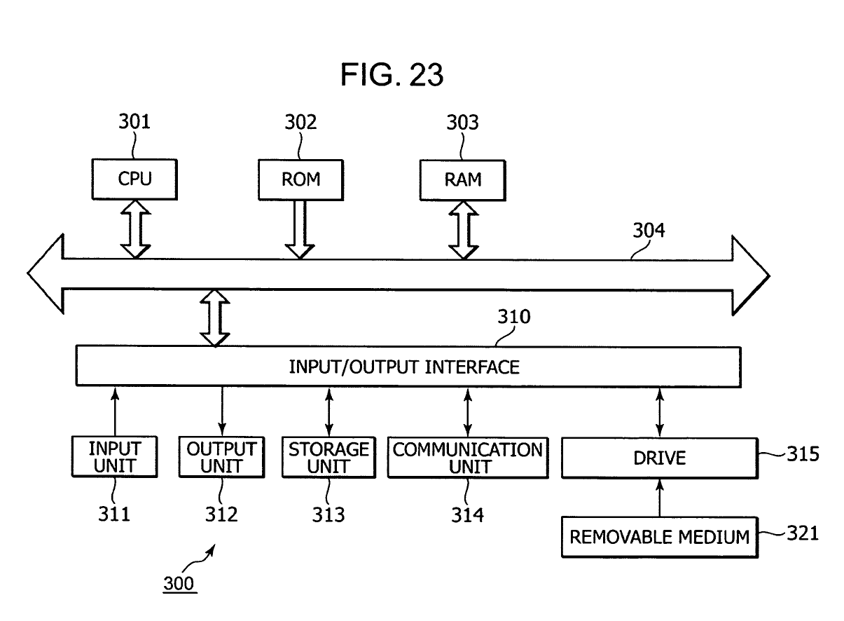

Although the above-described series of processes may be realized by hardware, they may be realized by software. In this case, a personal computer such as shown in FIG. 23 may be used.

In FIG. 23, a central processing unit (CPU) 301 of a personal computer 300 executes various processes in accordance with a program stored in a read only memory (ROM) 302 or a program loaded from the storage unit 313 to a RAM 303. RAM 303 stores data and the like necessary for CPU 301 to execute various processes, when necessary.

CPU 301, ROM 302 and RAM 303 are interconnected via a bus 304. The bus 304 is also connected to an input/output interface 310.

The input/output interface 310 is connected to an input unit 311 such as a keyboard and a mouse, an output unit 312 such as a cathode ray tube (CRT) and a liquid crystal display (LCD), the storage unit 313 made of a hard disk or the like, and a communication unit 314 made of a modem or the like. A communication unit 314 executes a communication process via a network including the Internet.

The input/output interface 310 is also connected to a drive 315 when necessary. A removable medium 321 such as a magnetic disk, an optical disk, a magnetic optical disk and a semiconductor memory is loaded in the drive. A computer program read from the removal medium is installed in the storage unit 313 when necessary.

When the above-described series of processes is executed by software, a program constituting the software is installed from the network and recording medium.

The recording medium includes, for example, as shown in FIG. 23, the removal medium 321 distributed to user for supplying a program separately from the apparatus main body, such as a magnetic disk (including a flexible disk), an optical disk (including a compact disk-read only memory (CD-ROM), and a digital versatile disk (DVD)), a magnetic optical disk (including a mini-disk (MD) (registered trademark)), a semiconductor memory, respectively recording a program, ROM 302, a hard disk included in the memory unit 313, or the like.

In this specification, steps describing the program provided by a recording medium contain not only a process to be executed time sequentially in the order of written statements but also a process to be executed parallel or independently without being processed time sequentially.

In this specification, a system is the whole apparatus including a plurality of devices (apparatus).

The structure described as one apparatus in the foregoing may be divided and structured as a plurality of apparatus. Conversely, the structure described as a plurality of apparatus in the foregoing may be integrated as one apparatus. The structure other than that described above may be added to the structure of each apparatus. If the structure and operation as the whole system are substantially the same, a portion of the structure of an apparatus may be included in the structure of another apparatus. Namely, the embodiments of the present invention are not limited to the embodiments described above, but various modifications are possible within the scope not departing from the main features of the present invention.

The present invention is applicable to an information processing apparatus.

The present document contains subject matter related to Japanese Patent Application No. 2006-227866 filed in the Japan Patent Office on Aug. 24, 2006, the entire content of which being incorporated herein by reference.

What is claimed is:

1. A network analysis assisting apparatus for assisting analysis of a network formed from a plurality of nodes and edges indicating interconnection between the nodes, comprising:
edge attribute setting means for setting an edge attribute indicating a meaning of the interconnection, to each of the edges.

2. The network analysis assisting apparatus according to claim 1, further comprising:
display control means for visualizing the network as a graph and displaying the graph on a monitor,
wherein the display control means displays the graph so as to indicate the edge attributes by visual features.

3. The network analysis assisting apparatus according to claim 2, further comprising:
edge attribute selecting means for receiving a designation of the edge attribute, and selecting and extracting edges having the designated edge attribute and nodes connected to the edges, from the network,
wherein the display control means display only the edges and the nodes selected by the edge attribute selecting means.

4. The network analysis assisting apparatus according to claim 1, further comprising:
edge designation analyzing means for receiving a designation of the edge attribute, and extracting a node group interconnected by edges having the designated edge attribute, from the network.

5. The network analysis assisting apparatus according to claim 1, further comprising:
score calculating means for calculating a node score representative of a weight of each of the nodes.

6. The network analysis assisting apparatus according to claim 5, wherein:
based on an edge score representative of a weight of an edge connected to a target node for process, the score calculating means calculates the node score of the target node for process.

7. The network analysis assisting apparatus according to claim 5, wherein:
based on a node score of another node connected via the edge to a target node for process, the node score of the target node for process is calculated.

8. A network analysis assisting method for assisting analysis of a network formed from a plurality of nodes and edges indicating interconnection between the nodes, the method comprising:
setting an edge attribute indicating a meaning of the interconnection, to each of the edges.

9. A program executable by a computer for controlling a process of assisting analysis of a network formed from a plurality of nodes and edges indicating interconnection between the nodes, wherein:
the program makes the computer execute an edge attribute setting step for setting an edge attribute indicating a meaning of the interconnection to each of the edges.

10. A recording medium recording the program recited in claim 9.

11. A network analysis assisting apparatus for assisting analysis of a network formed from a plurality of nodes and edges indicating interconnection between the nodes, the apparatus comprising:
an edge attribute setting unit that sets an edge attribute indicating a meaning of the interconnection, to each of the edges.
